(19) United States
(12) Patent Application Publication
(10) Pub. No.: US 2023/0379181 A1
(43) Pub. Date: Nov. 23, 2023

(54) BLOCKCHAIN ON-CHAIN METHOD, ELECTRONIC DEVICE, AND STORAGE MEDIUM

(71) Applicant: ZTE CORPORATION, Guangdong (CN)

(72) Inventors: Zhuang LIU, Guangdong (CN); Dapeng LI, Guangdong (CN); Yin GAO, Guangdong (CN); Yingjun ZHOU, Guangdong (CN)

(21) Appl. No.: 18/029,991

(22) PCT Filed: Jan. 14, 2022
(86) PCT No.: PCT/CN2022/072024

§ 371 Date: Apr. 3, 2023

(30) Foreign Application Priority Data
Mar. 29, 2021 (CN) 202110336467.3

(51) Int. Cl. H04L 9/00

(52) U.S. Cl. CPC H04L 9/50

(57) ABSTRACT

A blockchain on-chain method includes receiving at least one piece of blockchain on-chain configuration information; and controlling on-chained data collection and data on-chain of a first network element and/or a second network element according to the received at least one piece of blockchain on-chain configuration information. In this manner, the blockchain technology is implemented in the wireless communication network, and the data on-chain of multiple base stations by the wireless communication network is supported, thereby improving the security and integrity of data communication.

This application claims priority to Chinese Patent Application No. 202110336467.3 filed with the China National Intellectual Property Administration (CNIPA) on Mar. 29, 2021, the disclosure of which is incorporated herein by reference in its entirety.

### TECHNICAL FIELD

The present application relates to the technical field of wireless communications, for example, a blockchain on-chain method and apparatus, an electronic device, and a storage medium.

### BACKGROUND

The blockchain is a distributed ledger technology that originated from Bitcoin and has many advantages such as security, transparency and immutability. This technology stores data through a block-chain structure, and updates and synchronizes data using a consensus mechanism of nodes. The consensus mechanism is a core component of the blockchain technology that enables distributed nodes that do not trust each other to agree on certain information. The main process is that when a new block is added, some nodes need audit transactions and other nodes need to verify transaction; when the verification is passed, it means a consensus is reached, thereby achieving trusted data storage; and based on this, cryptography is used to ensure that the data on the chain cannot be forged or tampered with. A smart contract is a collection of program code recorded on the blockchain. The smart contract is used so that the data stored on the blockchain can be implemented automatically, thereby ensuring that established rules are strictly enforced.

Blockchains may be classified into three categories, including public blockchains, consortium blockchains, and private blockchains. Participants in the public chain include all users, and any user can read and write data, conduct a transaction, and confirm a consensus. The consortium blockchain allows only members within a consortium to participate, an organization of the members run one or more nodes, and the permissions for data read/write and transaction are executed according to the rules of the consortium. The write access in the private blockchain is restricted to one organization and the private blockchain is generally used within an enterprise.

The distributed ledger technology is applied to data traceability, especially in the field of product data traceability. The distributed ledger technology is used for product data traceability to achieve the sharing, replication and synchronization of product data among network member nodes. One of the network member nodes stores the generated product data in the distributed ledger and performs synchronization with other network member nodes so that other authorized network member nodes can read the product data, ensuring that the data is unique and tamper-proof.

The distributed ledger technology is based on a blockchain structure. The blockchain is composed of blocks connected by a chain structure, and each block includes generation time, a root hash value of a current block, a root hash value of a previous block, and a record the block contains. In a blockchain-based information traceability system, the information to be traced is added to the blockchain in sequence. When the information is added to the blockchain, a unique identity document (ID) is generated for the information. In a traceability information query process, traceability information is queried in the blockchain, and the uniqueness of the product ID is confirmed. Each blockchain participant holds the entire blockchain, and new information added by any participant is synchronized to the blockchains held by other participants. In the same way, the participant can also check the information added by other participants in the blockchain, thereby achieving the purpose of traceability.

In recent years, the blockchain technology has become a research hotspot in academia and has gradually been applied to various fields in the industry, and the application of the blockchain in the communication system is an emerging direction.

However, at present, mainstream operators at home and abroad are actively exploring the application of the blockchain in the communication system and have found that the consortium blockchain is the most suitable for operator application scenarios and that two major application directions are 5G edge computing and 5G co-construction and sharing. The distributed characteristics of the blockchain tend to be consistent with an edge computing architecture, and the combination of the blockchain with edge device nodes is conducive to resource complementarity and the expansion of new services. In terms of co-construction and sharing, untrusted parties are required to participate and cooperate. Therefore, the blockchain technology may be used to achieve trusted data sharing. The application scenarios involved include roaming settlement, data sharing, resource allocation, and operation and maintenance management. At the same time, relevant base station measurement data and relevant key performance indicator (KPI) data, as well as user equipment (UE) measurement, can be stored in the blockchain as on-chained data, which can be used as the trusted storage to prevent tampering and support multi-party sharing.

The on-chained data used for the trusted storage in 5G may include base station side data and UE data. Now, the 5G system supports the UE to maintain connections with two base stations at the same time. The implementation of the data on-chain process of multiple base stations in the case where one UE is connected to multiple base stations cannot currently be supported in the 5G system.

In addition, the 5G base station in the related art may be divided into a centralized unit (CU) entity and a distributed unit (DU) entity, and one base station may include one CU and multiple DUs, where the CU includes a layer 3 control plane function protocol stack entity and a packet data convergence protocol (PDCP) stack entity, and the DU includes a radio link control (RLC) protocol stack entity or a medium access control (MAC) protocol stack entity, a physical layer, and a radio frequency unit. The implementation of the data on-chain process of one or more DUs in the case where the UE is connected to one or more DUs cannot currently be supported in the 5G system.

### SUMMARY

The main object of embodiments of the present application is to provide a blockchain on-chain method and apparatus, an electronic device, and a storage medium, aiming at achieving the blockchain technology in a wireless communication network and data on-chain of multiple base stations in the wireless communication network, thereby improving the security and integrity of data communication.

An embodiment of the present application provides a blockchain on-chain method. The method includes receiving at least one piece of blockchain on-chain configuration information; and controlling on-chained data collection and data on-chain of a first network element and/or a second network element according to the received at least one piece of blockchain on-chain configuration information.

An embodiment of the present application further provides a blockchain on-chain method. The method includes receiving at least one piece of blockchain on-chain configuration information; and controlling on-chained data collection and data on-chain according to the at least one piece of blockchain on-chain configuration information.

An embodiment of the present application further provides a blockchain on-chain apparatus. The apparatus includes a configuration receiving module and an on-chain control module.

The configuration receiving module is configured to receive at least one piece of blockchain on-chain configuration information from an operation administration and maintenance (OAM) entity and/or a core network.

The on-chain control module is configured to control on-chained data collection and data on-chain of a first network element and/or a second network element according to the received at least one piece of blockchain on-chain configuration information.

An embodiment of the present application further provides a blockchain on-chain apparatus. The apparatus includes a configuration receiving module and an on-chain control module.

The configuration receiving module is configured to receive at least one piece of blockchain on-chain configuration information.

The on-chain control module is configured to control on-chained data collection and data on-chain according to the at least one piece of blockchain on-chain configuration information.

An embodiment of the present application further provides an electronic device. The electronic device includes one or more processors and a memory configured to store one or more programs.

The one or more programs, when executed by the one or more processors, cause the one or more processors to perform the blockchain on-chain method according to any embodiment of the present application.

An embodiment of the present application further provides a computer-readable storage medium, which is configured to store a computer program, where the computer program is executed by a processor to perform the blockchain on-chain method according to any embodiment of the present application.

In the embodiments of the present application, at least one piece of blockchain on-chain configuration information is received from the OAM entity and/or the core network; and the on-chained data collection and the data on-chain of the first network element and/or the second network element are controlled according to the received at least one piece of blockchain on-chain configuration information. In this manner, the blockchain technology is implemented in the wireless communication network, and the data on-chain of multiple base stations by the wireless communication network is supported, thereby improving the security and integrity of data communication.

### BRIEF DESCRIPTION OF DRAWINGS

FIG. 1 is a flowchart of a blockchain on-chain method according to an embodiment of the present application;

FIG. 2 is a flowchart of a blockchain on-chain method according to an embodiment of the present application;

FIG. 3 is a flowchart of a blockchain on-chain method according to an embodiment of the present application;

FIG. 4 is a flowchart of a blockchain on-chain method according to an embodiment of the present application;

FIG. 5 is a flowchart of a blockchain on-chain method according to an embodiment of the present application;

FIG. 6 is a flowchart of a blockchain on-chain method according to an embodiment of the present application;

FIG. 7 is a flowchart of a blockchain on-chain method according to an embodiment of the present application;

FIG. 8 is a flowchart of a blockchain on-chain method according to an embodiment of the present application;

FIG. 9 is a flowchart of a blockchain on-chain method according to an embodiment of the present application;

FIG. 10 is a flowchart of a blockchain on-chain method according to an embodiment of the present application;

FIG. 11 is a flowchart of a blockchain on-chain method according to an embodiment of the present application;

FIG. 12 is a flowchart of a blockchain on-chain method according to an embodiment of the present application;

FIG. 13 is a schematic diagram of a blockchain on-chain method according to an embodiment of the present application;

FIG. 14 is a schematic diagram of a blockchain on-chain method according to an embodiment of the present application;

FIG. 15 is a schematic diagram of a blockchain on-chain method according to an embodiment of the present application;

FIG. 16 is a schematic diagram of a blockchain on-chain method according to an embodiment of the present application;

FIG. 17 is a schematic diagram of a blockchain suspension processing method according to an embodiment of the present application;

FIG. 18 is a schematic diagram of a blockchain suspension processing method according to an embodiment of the present application;

FIG. 19 is a schematic diagram of a blockchain on-chain method according to an embodiment of the present application;

FIG. 20 is a structural diagram of a blockchain on-chain apparatus according to an embodiment of the present application;

FIG. 21 is a structural diagram of a blockchain on-chain apparatus according to an embodiment of the present application; and

FIG. 22 is a structural diagram of an electronic device according to an embodiment of the present application.

### DETAILED DESCRIPTION

Suffixes such as “module”, “part” or “unit” used to indicate elements in the subsequent description are merely used to facilitate the description of the present application and have no particular meaning in themselves. Therefore, “module”, “part” or “unit” may be used in a mixed manner.

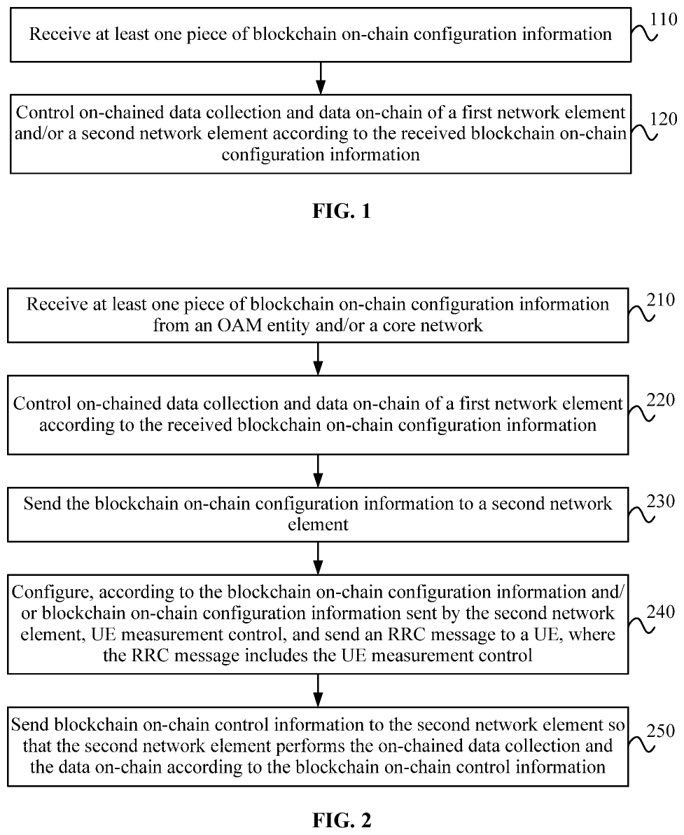

FIG. 1 is a flowchart of a blockchain on-chain method according to an embodiment of the present application. The embodiment of the present application is applicable to the case of transmission data on-chain in a wireless communication network, and the method may be performed by a blockchain on-chain apparatus. The apparatus may be implemented by software and/or hardware and is generally applied to a first network element. Referring to FIG. 1, the method provided in the embodiment of the present application specifically includes operation 110 and operation 120.

In the operation 110, at least one piece of blockchain on-chain configuration information is received.

The blockchain on-chain configuration information may be information configured for blockchain data on-chain, where the information is used for controlling the first network element to add transmission data to the blockchain.

In the embodiment of the present application, the first network element may receive the blockchain on-chain configuration information sent by an OAM entity, a core network or a second network element.

In the operation 120, on-chained data collection and data on-chain of the first network element and/or the second network element are controlled according to the received blockchain on-chain configuration information.

The second network element may be another network device connected to the first network element, and the second network element and the first network element may be connected in a wired manner or in a wireless manner.

Specifically, the first network element may be configured according to the received blockchain on-chain configuration information, and according to the configuration, the data that needs to be on-chained is collected and the collected data is uploaded to the blockchain. Further, the first network element may transmit the acquired blockchain on-chain configuration information to the second network element so that the second network element may perform the on-chained data collection and the data on-chain according to the blockchain on-chain configuration information.

In the embodiment of the present application, at least one piece of blockchain on-chain configuration information is received from the OAM entity and/or the core network; and the on-chained data collection and the data on-chain of the first network element and/or the second network element are controlled according to the received at least one piece of blockchain on-chain configuration information. In this manner, the blockchain technology is implemented in the wireless communication network, and the data on-chain of multiple base stations by the wireless communication network is supported, thereby improving the security and integrity of data communication.

Further, based on the preceding embodiment of the present application, the receiving the at least one piece of blockchain on-chain configuration information includes at least one of: receiving the at least one piece of blockchain on-chain configuration information from the OAM entity and/or the core network; or, receiving blockchain on-chain configuration information sent by the second network element.

The OAM entity may be an entity for operation administration and maintenance, and specifically may be an entity device that operates, manages, and maintains an operation network. For example, the OAM entity may be an operator server. The core network may be a network enabling a data request or a call request in the communication network to be transferred to different networks. The second network element may be another network device connected to the first network element, and the second network element and the first network element may be connected in a wired manner or in a wireless manner.

In the embodiment of the present application, the first network element may receive the blockchain on-chain configuration information from the OAM entity and/or the core network, or the blockchain on-chain configuration information is acquired through the second network element.

Further, based on the preceding embodiment of the present application, the method further includes sending the blockchain on-chain configuration information to the second network element so that the second network element performs the on-chained data collection and the data on-chain according to the blockchain on-chain configuration information.

Further, based on the preceding embodiment of the present application, UE measurement control is configured according to the blockchain on-chain configuration information and/or the blockchain on-chain configuration information sent by the second network element, and a radio resource control (RRC) message is sent to a UE, where the RRC message includes UE side measurement control.

Specifically, the first network element may send the received blockchain on-chain configuration information to the second network element, and the second network element performs configuration according to the blockchain on-chain configuration information, and performs the on-chained data collection and the data on-chain after the configuration is completed.

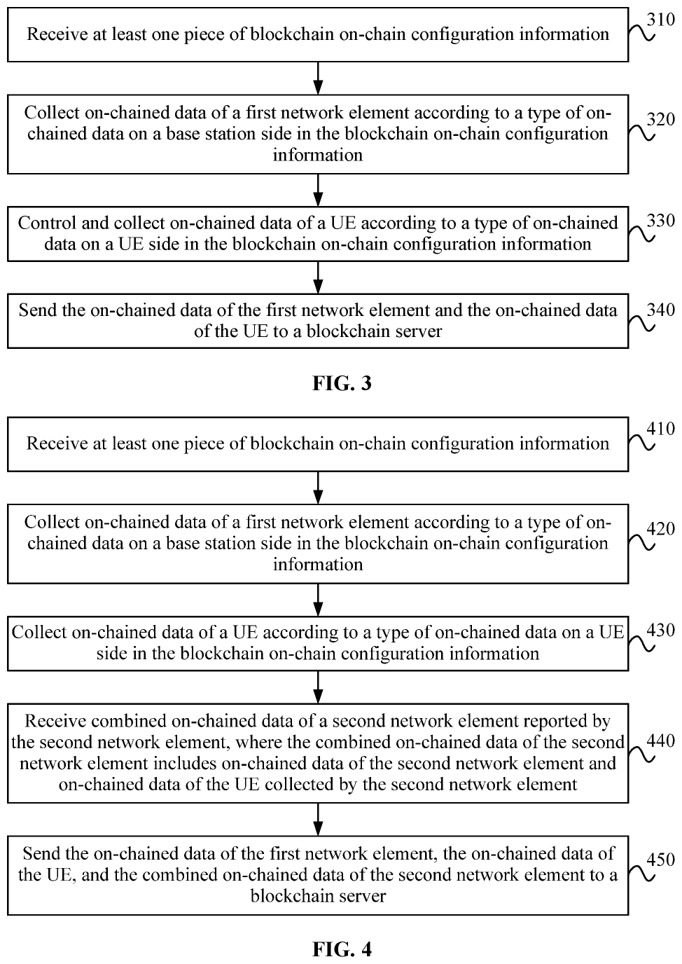

FIG. 2 is a flowchart of a blockchain on-chain method according to an embodiment of the present application. The embodiment of the present application is an embodiment based on the preceding embodiment of the present application. Referring to FIG. 2, the method provided in the embodiment of the present application specifically includes the following operations 210-230.

In the operation 210, at least one piece of blockchain on-chain configuration information is received from an OAM entity and/or a core network.

In the operation 220, on-chained data collection and data on-chain of a first network element are controlled according to the received blockchain on-chain configuration information.

In the operation 230, blockchain on-chain configuration information corresponding to a radio access technology (RAT) type to which a second network element belongs is sent to the second network element according to the RAT type so that the second network element performs the on-chained data collection and the data on-chain according to the blockchain on-chain configuration information.

The RAT type may be information reflecting an underlying physical connection manner of a network element and may indicate the type of the RAT used by the network element. The blockchain on-chain configuration information received by the first network element may be a set of blockchain on-chain configuration information, and one or more types of blockchain on-chain information may be set for different RAT types in the set.

In the embodiment of the present application, the first network element may, according to the RAT type to which the second network element belongs, search for the blockchain on-chain configuration information corresponding to the RAT type in the received blockchain on-chain configuration information, and transmit the blockchain on-chain configuration information to the second network element; and the second network element performs configuration according to the blockchain on-chain configuration information, and performs the on-chained data collection and the data on-chain after the configuration is completed.

FIG. 2 is a flowchart of a blockchain on-chain method according to an embodiment of the present application. The embodiment of the present application is an embodiment based on the preceding embodiment of the present application. Referring to FIG. 2, the method provided in the embodiment of the present application specifically includes the following operations 210-250.

In the operation 210, at least one piece of blockchain on-chain configuration information is received from an OAM entity and/or a core network.

In the operation 220, on-chained data collection and data on-chain of a first network element are controlled according to the received blockchain on-chain configuration information.

In the operation 230, the blockchain on-chain configuration information is sent to a second network element so that the second network element performs the on-chained data collection and the data on-chain according to the blockchain on-chain configuration information.

In the operation 240, UE measurement control is configured according to the blockchain on-chain configuration information and/or the blockchain on-chain configuration information sent by the second network element, and an RRC message is sent to the UE, where the RRC message includes the UE measurement control.

The UE measurement control may be a control parameter for the first network element to control a UE to perform measurement, and the UE measurement control may be determined according to the blockchain on-chain configuration information.

In the embodiment of the present application, after acquiring the blockchain on-chain configuration information, the first network element may use the blockchain on-chain to configure the UE measurement control and send the UE measurement control to the UE through the RRC message so that the UE performs measurement.

In the operation 250, blockchain on-chain control information is sent to the second network element so that the second network element performs the on-chained data collection and the data on-chain according to the blockchain on-chain control information.

The blockchain on-chain control information may be information for the first network element to control the second network element to perform the on-chained data collection and the data on-chain.

In the embodiment of the present application, the first network element sends the blockchain on-chain control information to the second network element to trigger the second network element to perform the on-chained data collection and the data on-chain.

Further, based on the preceding embodiment of the present application, the blockchain on-chain configuration information is received from at least one of the following messages of the OAM entity and/or the core network: a UE text establishment message, a protocol data unit (PDU) session establishment message, or a PDU session modification message.

In the embodiment of the present application, the first network element acquires the blockchain on-chain configuration information in the UE text establishment message, the PDU session establishment message, and the PDU session modification message sent by the OAM entity and/or the core network.

Further, based on the preceding embodiment of the present application, the blockchain on-chain configuration information is sent to the second network element through at least one of: a slave base station addition request message, a slave base station update request message, a UE text establishment request message, a UE text update request message, or a blockchain on-chain activation request message.

In the embodiment of the present application, the first network element sends the blockchain on-chain configuration information to the second network element through at least one of the following messages: the slave base station addition request message, the slave base station update request message, the UE text establishment request message, the UE text update request message, or the blockchain on-chain activation request message.

Further, based on the preceding embodiment of the present application, the blockchain on-chain control information is sent to the second network element through at least one of: a slave base station addition request message, a slave base station update request message, a UE text establishment request message, a UE text update request message, or a blockchain on-chain control request message.

In the embodiment of the present application, the first network element sends the blockchain on-chain control information to the second network element through at least one of the following messages: the slave base station addition request message, the slave base station update request message, the UE text establishment request message, the UE text update request message, or the blockchain on-chain control request message.

FIG. 3 is a flowchart of a blockchain on-chain method according to an embodiment of the present application. The embodiment of the present application is an embodiment based on the preceding embodiment of the present application. Referring to FIG. 3, the method provided in the embodiment of the present application specifically includes the following operations 310-340.

In the operation 310, at least one piece of blockchain on-chain configuration information is received.

In the operation 320, on-chained data of a first network element is collected according to a type of on-chained data on a base station side in the blockchain on-chain configuration information.

The type of on-chained data on the base station side may be a data type of collected on-chained data in the first network element.

In the embodiment of the present application, the on-chained data may be collected according to the type of on-chained data on the base station side in the blockchain on-chain configuration information, and the collected data may be recorded as the on-chained data of the first network element.

In the operation 330, on-chained data of a UE is controlled and collected according to a type of on-chained data on a UE side in the blockchain on-chain configuration information.

The type of on-chained data on the UE may be a data type of collected on-chained data in the UE.

Specifically, the UE may be controlled to collect data of the corresponding type according to the type of on-chained data on the UE side, and the collected data may be recorded as the on-chained data of the UE.

In the operation 340, the on-chained data of the first network element and the on-chained data of the UE are sent to a blockchain server.

In the embodiment of the present application, the first network element may upload only the on-chained data of the UE and the on-chained data of the first network element to the blockchain server to implement the data on-chain.

FIG. 4 is a flowchart of a blockchain on-chain method according to an embodiment of the present application. The embodiment of the present application is an embodiment based on the preceding embodiment of the present application. Referring to FIG. 4, the method provided in the embodiment of the present application specifically includes the following operation 410-450.

In the operation 410, at least one piece of blockchain on-chain configuration information is received.

In the operation 420, on-chained data of a first network element is collected according to a type of on-chained data on a base station side in the blockchain on-chain configuration information.

In the operation 430, on-chained data of a UE is collected according to a type of on-chained data on a UE side in the blockchain on-chain configuration information.

In the operation 440, combined on-chained data of a second network element reported by the second network element is received, where the combined on-chained data of the second network element includes on-chained data of the second network element and on-chained data of the UE collected by the second network element.

The combined on-chained data of the second network element may be data uploaded by the second network element to the first network element for the data on-chain, and the combined on-chained data of the second network element includes the on-chained data of the second network element collected at the second network element and the on-chained data of the UE collected at the second network element.

In the embodiment of the present application, the first network element may receive the combined on-chained data of the second network element sent by the second network element, and the combined on-chained data of the second network element may include the on-chained data of the second network element collected by the second network element and the on-chained data of the UE collected by the second network element.

In the operation 450, the on-chained data of the first network element, the on-chained data of the UE, and the combined on-chained data of the second network element are sent to a blockchain server.

Specifically, the first network element may be used as an execution entity for the data on-chain, and the on-chained data of the first network element, the on-chained data of the UE, and the combined on-chained data of the second network element are all sent to the blockchain server at the first network element.

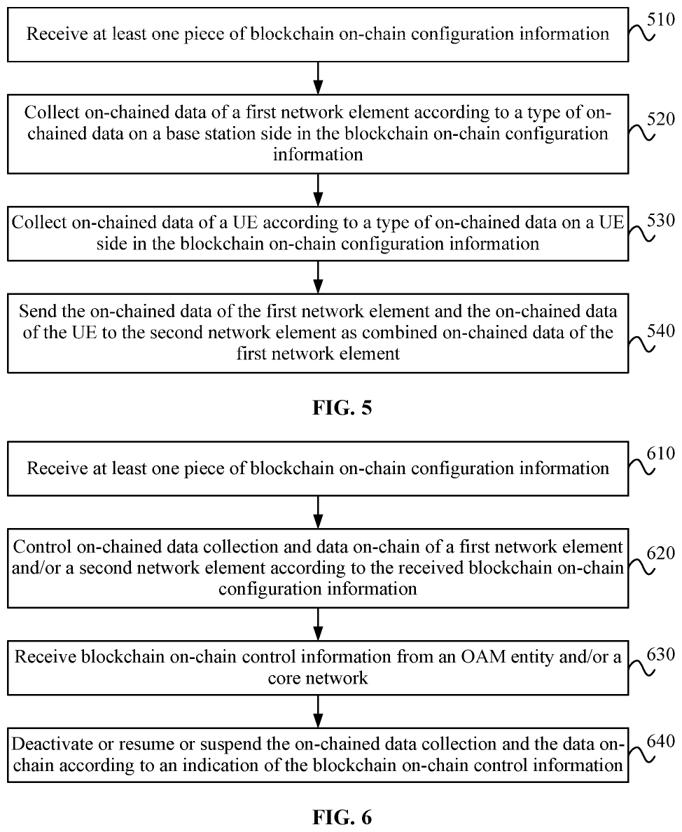

FIG. 5 is a flowchart of a blockchain on-chain method according to an embodiment of the present application. The embodiment of the present application is an embodiment based on the preceding embodiment of the present application. Referring to FIG. 5, the method provided in the embodiment of the present application specifically includes the following operations 510-540.

In the operation 510, at least one piece of blockchain on-chain configuration information is received.

In the operation 520, on-chained data of a first network element is collected according to a type of on-chained data on a base station side in the blockchain on-chain configuration information.

In the operation 530, on-chained data of a UE is collected according to a type of on-chained data on a UE side in the blockchain on-chain configuration information.

In the operation 540, the on-chained data of the first network element and the on-chained data of the UE are sent to a second network element as combined on-chained data of the first network element.

In the embodiment of the present application, the second network element may be used as the execution entity for the data on-chain, the first network element may send the on-chained data of the first network element and the on-chained data of the UE to the second network element, and the second network element receives the combined on-chained data of the first network element including the on-chained data of the first network element and the on-chained data of the UE and sends the combined on-chained data of the first network element to the blockchain server to implement the data on-chain.

FIG. 6 is a flowchart of a blockchain on-chain method according to an embodiment of the present application. The embodiment of the present application is an embodiment based on the preceding embodiment of the present application. Referring to FIG. 6, the method provided in the embodiment of the present application specifically includes the following operations 610-640.

In the operation 610, at least one piece of blockchain on-chain configuration information is received.

In the operation 620, on-chained data collection and data on-chain of a first network element and/or a second network element are controlled according to the received blockchain on-chain configuration information.

In the operation 630, blockchain on-chain control information is received from an OAM entity and/or a core network.

The blockchain on-chain control information may be information for controlling a data on-chain process, where the data on-chain process may include a process of activating the data on-chain or a process of deactivating the data on-chain.

Specifically, the first network element may receive the blockchain on-chain control information sent by the OAM entity and/or the core network.

In the operation 640, deactivation, resumption or suspension is instructed to be performed on the on-chained data collection and the data on-chain according to the blockchain on-chain control information.

In the embodiment of the present application, after receiving the blockchain on-chain control information, the first network element may trigger a corresponding blockchain processing operation, for example, the operation of activating, resuming or suspending the on-chained data collection and the data on-chain.

Further, based on the preceding embodiment of the present application, the operation in which where deactivation, resumption or suspension is instructed to be performed on the on-chained data collection and the data on-chain according to the blockchain on-chain control information includes at least one of: according to the blockchain on-chain control information, the first network element is instructed to deactivate, resume or suspend the on-chained data collection and the data on-chain; the blockchain on-chain control information is sent to the second network element to instruct the second network element to deactivate, resume or suspend the on-chained data collection and the data on-chain; or, the blockchain on-chain control information is sent to a UE to instruct the UE to deactivate, resume or suspend on-chained data measurement.

In the embodiment of the present application, the operation of deactivating, resuming or suspending the on-chained data collection and the data on-chain of the blockchain specially includes an operation on a local first network element, that is, an operation of instructing the first network element to deactivate, resume or suspend the on-chained data collection and the data on-chain. An operation on the second network element is further included, that is, an operation of controlling the second network element to deactivate, resume or suspend the on-chained data collection and the data on-chain. An operation on the UE is further included, that is, an operation of instructing the terminal to deactivate, resume or suspend the on-chained data measurement.

Further, based on the preceding embodiment of the present application, the blockchain on-chain configuration information includes at least one of the following parameters: an indication about whether a blockchain is adapted to a radio access type, a type of on-chained data on a base station side, a type of on-chained data on a UE side, a blockchain on-chain session identifier, or a blockchain on-chain server address.

Further, based on the preceding embodiment of the present application, the blockchain on-chain control information includes at least one of the following parameters: a blockchain on-chain session identifier, a UE identifier, a blockchain on-chain resumption indication, a blockchain on-chain suspension indication, a blockchain deactivation indication, and a blockchain on-chain activation indication.

Further, based on the preceding embodiment of the present application, each piece of blockchain on-chain configuration information is configured for one radio access type.

Further, based on the preceding embodiment of the present application, the second network element includes at least one of: a slave base station or a base station DU.

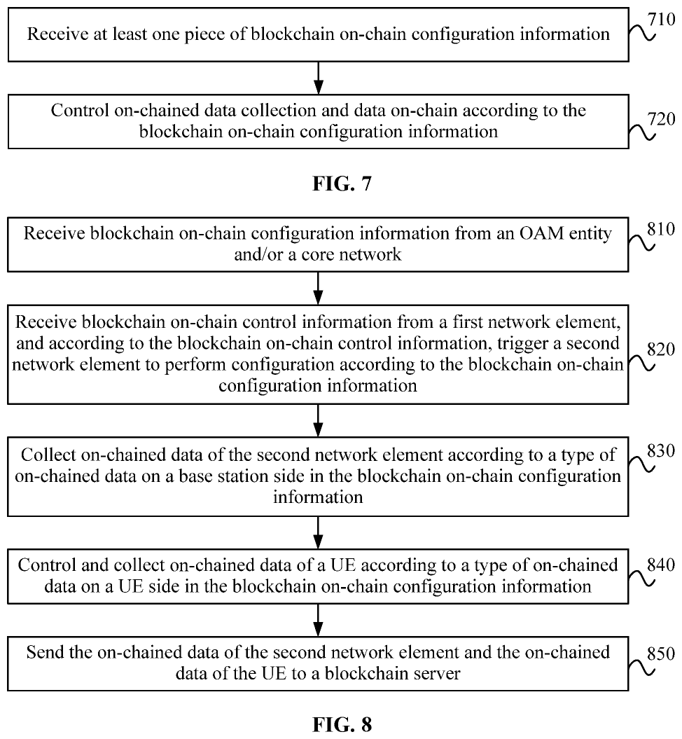

FIG. 7 is a flowchart of a blockchain on-chain method according to an embodiment of the present application. The embodiment of the present application is applicable to the case of transmission data on-chain in a wireless communication network, and the method may be performed by a blockchain on-chain apparatus. The apparatus may be implemented by software and/or hardware and is generally applied to a second network element. Referring to FIG. 7, the method provided in the embodiment of the present application specifically includes the following operations 710-720.

In the operation 710, at least one piece of blockchain on-chain configuration information is received.

Specifically, the second network element may receive the blockchain on-chain configuration information, where the blockchain on-chain configuration information may be sent by an OAM entity and/or a core network or may be sent by a first network element.

In the operation 720, on-chained data collection and data on-chain are controlled according to the blockchain on-chain configuration information.

In the embodiment of the present application, the second network element may perform the on-chained data collection and the data on-chain according to the blockchain on-chain configuration information.

In the embodiment of the present application, at least one piece of blockchain on-chain configuration information is received; and the on-chained data collection and the data on-chain of the first network element and/or the second network element are controlled according to the received blockchain on-chain configuration information. In this manner, the blockchain technology is implemented in the wireless communication network, and the data on-chain of multiple base stations by the wireless communication network is supported, thereby improving the security and integrity of data communication.

Further, based on the preceding embodiment of the present application, the operation in which the at least one piece of blockchain on-chain configuration information is received includes at least one of: receiving the blockchain on-chain configuration information from a first network element; or, receiving the blockchain on-chain configuration information from an OAM entity and/or a core network.

The OAM entity may be an entity for operation administration and maintenance, and specifically may be an entity device that operates, manages, and maintains an operation network. For example, the OAM entity may be an operator server. The core network may be a network enabling a data request or a call request in the communication network to be transferred to different networks. The first network element may be another network device connected to the second network element, and the second network element and the first network element may be connected in a wired manner or in a wireless manner.

In the embodiment of the present application, the second network element may receive the blockchain on-chain configuration information from the OAM entity and/or the core network, or the blockchain on-chain configuration information is acquired through the first network element.

FIG. 8 is a flowchart of a blockchain on-chain method according to an embodiment of the present application. The embodiment of the present application is an embodiment based on the preceding embodiment of the present application. Referring to FIG. 8, the method provided in the embodiment of the present application specifically includes the following operations 810-850.

In the operation 810, blockchain on-chain configuration information is received from an OAM entity and/or a core network.

In the operation 820, blockchain on-chain control information is received from a first network element, and according to the blockchain on-chain control information, a second network element is triggered to perform configuration according to the blockchain on-chain configuration information.

In the operation 830, on-chained data of the second network element is collected according to a type of on-chained data on a base station side in the blockchain on-chain configuration information.

In the operation 840, on-chained data on a UE is controlled and collected according to a type of on-chained data on a UE side in the blockchain on-chain configuration information.

In the operation 850, the on-chained data of the second network element and the on-chained data of the UE are sent to a blockchain server.

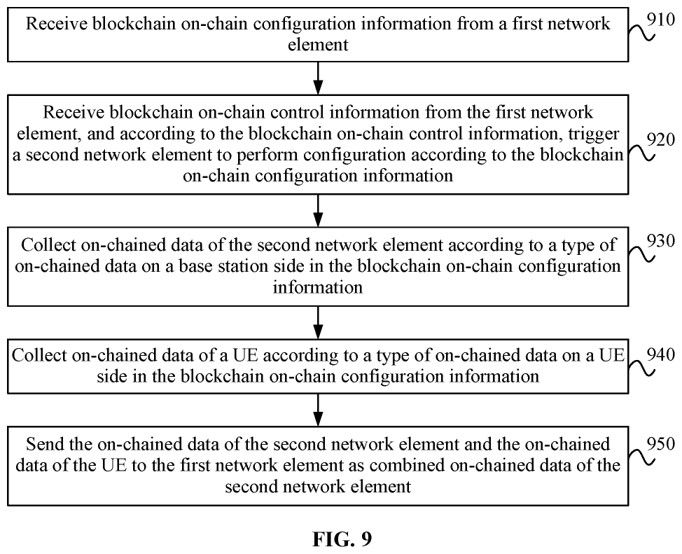

FIG. 9 is a flowchart of a blockchain on-chain method according to an embodiment of the present application. The embodiment of the present application is an embodiment based on the preceding embodiment of the present application. Referring to FIG. 9, the method provided in the embodiment of the present application specifically includes the following operations 910-950.

In the operation 910, blockchain on-chain configuration information is received from a first network element.

In the operation 920, blockchain on-chain control information is received from the first network element, and according to the blockchain on-chain control information, a second network element is triggered to perform configuration according to the blockchain on-chain configuration information.

In the operation 930, on-chained data of the second network element is collected according to a type of on-chained data on a base station side in the blockchain on-chain configuration information.

In the operation 940, on-chained data of a UE is collected according to a type of on-chained data of a UE side in the blockchain on-chain configuration information.

In the operation 950, the on-chained data of the second network element and the on-chained data of the UE are sent to the first network element as combined on-chained data of the second network element.

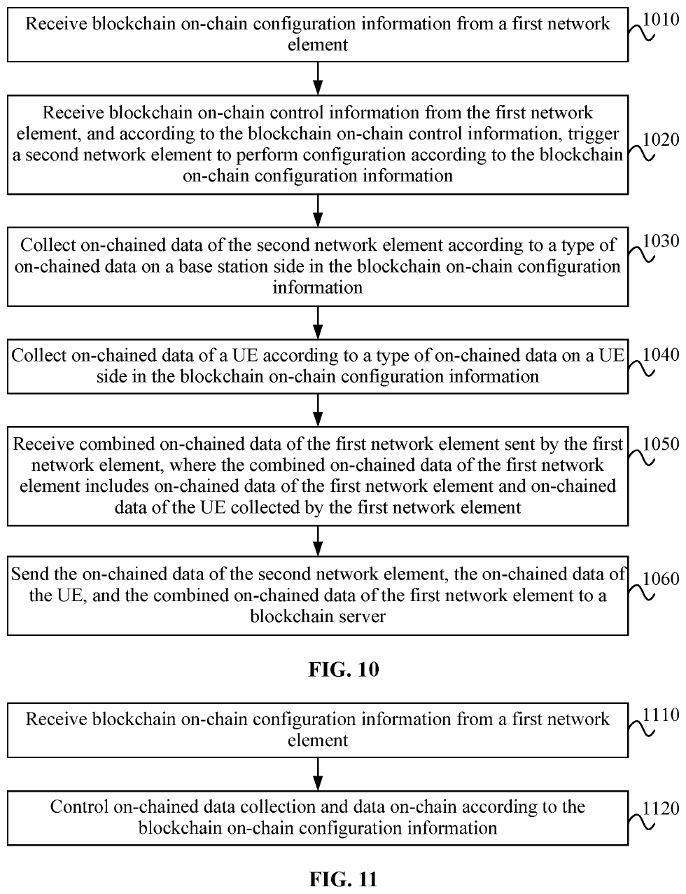

FIG. 10 is a flowchart of a blockchain on-chain method according to an embodiment of the present application. The embodiment of the present application is an embodiment based on the preceding embodiment of the present application. Referring to FIG. 10, the method provided in the embodiment of the present application specifically includes the following operations 1010-1060.

In the operation 1010, blockchain on-chain configuration information is received from a first network element.

In the operation 1020, blockchain on-chain control information is received from the first network element, and according to the blockchain on-chain control information, a second network element is triggered to perform configuration according to the blockchain on-chain configuration information.

In the operation 1030, on-chained data of the second network element is collected according to a type of on-chained data on a base station side in the blockchain on-chain configuration information.

In the operation 1040, on-chained data of a UE is collected according to a type of on-chained data on a UE side in the blockchain on-chain configuration information.

In the operation 1050, combined on-chained data of the first network element sent by the first network element is received, where the combined on-chained data of the first network element includes on-chained data of the first network element and on-chained data of the UE collected by the first network element.

In the operation 1060, the son-chained data of the second network element, the on-chained data of the UE, and the combined on-chained data of the first network element are sent to a blockchain server.

FIG. 11 is a flowchart of a blockchain on-chain method according to an embodiment of the present application. The embodiment of the present application is an embodiment based on the preceding embodiment of the present application. Referring to FIG. 11, the method provided in the embodiment of the present application specifically includes the following operations 1110-1120.

In the operation 1110, blockchain on-chain configuration information is received from a first network element.

In the operation 1120, on-chained data collection and data on-chain are controlled according to the blockchain on-chain configuration information.

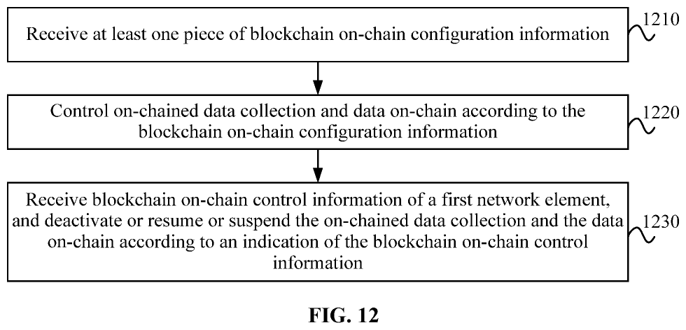

FIG. 12 is a flowchart of a blockchain on-chain method according to an embodiment of the present application. The embodiment of the present application is an embodiment based on the preceding embodiment of the present application. Referring to FIG. 12, the method provided in the embodiment of the present application specifically includes the following operations 1210-1230.

In the operation 1210, at least one piece of blockchain on-chain configuration information is received.

In the operation 1220, on-chained data collection and data on-chain are controlled according to the blockchain on-chain configuration information.

In the operation 1230, blockchain on-chain control information of a first network element is received, and deactivation, resumption or suspension is instructed to be performed on the on-chained data collection and the data on-chain according to the blockchain on-chain control information.

Further, based on the preceding embodiment of the present application, the method further includes that: blockchain on-chain control information is received from the first network element, the blockchain on-chain configuration information is generated according to a blockchain on-chain activation indication of the blockchain on-chain control information, and the blockchain on-chain configuration information is sent to the first network element.

In the embodiment of the present application, the second network element may also be used as a sender of the blockchain on-chain configuration information of the first network element, and when receiving the blockchain on-chain control information sent by the first network element, the second network element triggers a process of generating the blockchain on-chain configuration information, and may send the generated blockchain on-chain configuration information to the first network element.

Further, based on the preceding embodiment of the present application, the blockchain on-chain configuration information includes at least one of the following parameters: an indication about whether a blockchain is adapted to a radio access type, a type of on-chained data on a base station side, a type of on-chained data on a UE side, a blockchain on-chain session identifier, or a blockchain on-chain server address.

Further, based on the preceding embodiment of the present application, the blockchain on-chain control information includes at least one of the following parameters: a blockchain on-chain session identifier, a UE identifier, a blockchain on-chain resumption indication, a blockchain on-chain suspension indication, a blockchain deactivation indication, or a blockchain on-chain activation indication.

Further, based on the preceding embodiment of the present application, each piece of blockchain on-chain configuration information is configured for one radio access type.

Further, based on the preceding embodiment of the present application, the blockchain on-chain configuration information is received in at least one of the following messages of the first network element: a slave base station addition request message, a slave base station update request message, a UE text establishment request message, a UE text update request message, or a blockchain on-chain activation request message.

Further, based on the preceding embodiment of the present application, the blockchain on-chain control information is received in at least one of the following messages of the first network element: a slave base station addition request message, a slave base station update request message, a UE text establishment request message, a UE text update request message, or a blockchain on-chain control request message.

Further, based on the preceding embodiment of the present application, the first network element includes at least one of: a master base station or a base station CU.

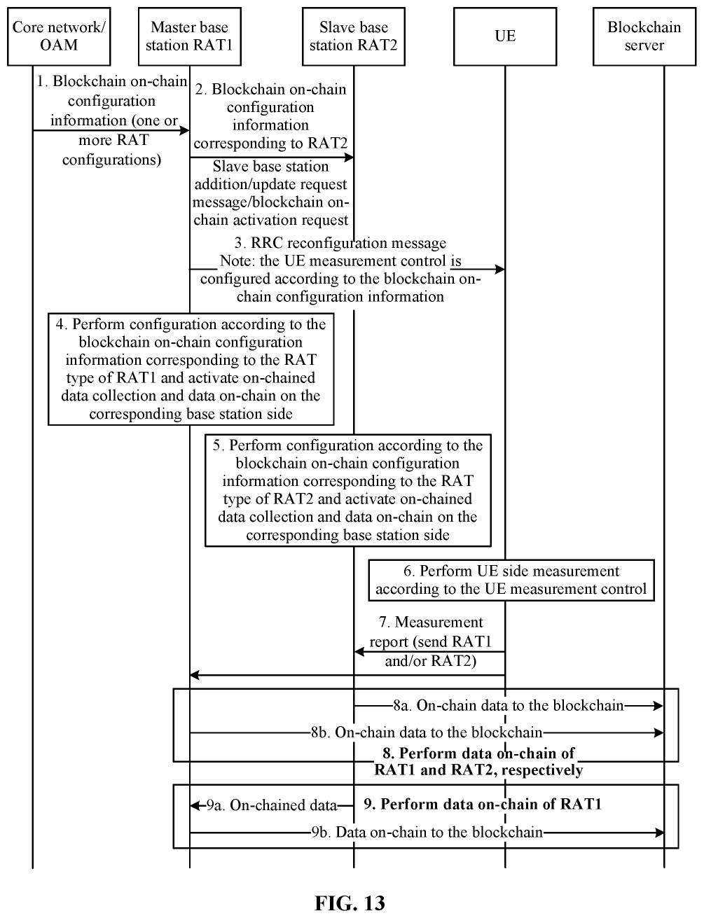

Exemplarily, the dual connectivity between the UE and the base station is taken as an example. In this example, the UE has established dual connectivity with the master base station and the slave base station, or the UE needs to establish dual connectivity with the master base station and the slave base station. In this embodiment, the focus is that the blockchain on-chain configuration on the slave base station is configured by the master base station. The master base station and the slave base station may be base stations of the same RAT type or base stations of different RAT types. Referring to FIG. 13, the on-chain activation and data on-chain process may be described below as operations 1 to 9b.

In the operation 1, in the process of UE text establishment or PDU session establishment and modification, the core network sends a message to the master base station at an NG interface, where the message may be a text establishment/modification request and a PDU session establishment/modification request message, and the message carries blockchain on-chain configuration information of one or more RATs. The blockchain on-chain configuration information includes one of the following parameters:
an indication about whether a blockchain configuration is applicable to a RAT type (for example, Long Term Evolution (LTE) and New Radio (NR)), which is used for indicating which radio technology the blockchain configuration is applicable to;
a type of data that needs to be on-chained on the base station side, which is used for indicating one or more types of data that the base station needs to perform collection and on-chain on;
a type of data that needs to be on-chained at the UE, which is used for indicating one or more types of data that the UE needs to perform collection and on-chain on;
a blockchain on-chain session identifier, which is used for identifying a specified blockchain on-chain session (task); or blockchain on-chain server Internet Protocol (IP) address information.

Alternatively, the blockchain on-chain configuration information of one or more RATs of the master base station is configured by the OAM entity.

According to the RAT type to which the base station belongs, the master base station configures the received blockchain on-chain configuration information of the corresponding RAT to the master base station. For example, if the master base station is an LTE base station, the blockchain on-chain configuration information of the corresponding LTE is configured to the master base station; or if the master base station is a 5G base station, the blockchain on-chain configuration information of the corresponding 5G base station is configured to the master base station.

In the operation 2, according to the RAT type to which the slave base station belongs, the master base station sends the blockchain on-chain configuration information of the corresponding RAT to the slave base station at an X2 or XN interface. The master base station may carry the blockchain on-chain configuration information in a slave base station addition/modification message or a blockchain on-chain activation request message. The slave base station configures the received blockchain on-chain configuration information to the slave base station.

In the operation 3, according to a type of data that needs to be on-chained at the UE in the blockchain on-chain configuration information configured by the master base station and a type of data that needs to be on-chained at the UE in the blockchain on-chain configuration information sent to the slave base station, the master base station configures UE side measurement, and sends measurement control to the UE by carrying the measurement control in an RRC message.

In the operation 4 and the operation 5, the master base station and the slave base station activate the collection and on-chain of the corresponding on-chained data according to the type of data that needs to be on-chained on the base station side in the respectively configured blockchain on-chain configuration information.

In the operation 6, the UE performs corresponding measurement according to the measurement control.

In the operation 7, the UE sends a measurement report to the master base station or the slave base station, where the measurement report includes relevant measurement specified in the measurement control.

In the operation 8 (the operation 8 and the operation 9 are alternative), the master base station and the slave base station perform data collection and form on-chained data sets respectively according to the type of on-chained data in the respectively configured blockchain on-chain configuration information, and send the corresponding on-chained data sets to specific blockchain servers according to blockchain service addresses, respectively.

Specifically, in the operation 8a, the master base station collects the on-chained data of the base station according to the type of data that needs to be on-chained at the base station in the blockchain on-chain configuration information configured by the master base station. Moreover, if the master base station receives a UE measurement report, the master base station collects the on-chained data corresponding to the UE side from the UE measurement report, and the master base station forms the collected data into an on-chained data set and sends the data set to the blockchain server.

In the operation 8b, the slave base station collects the on-chained data of the base station according to the type of data that needs to be on-chained at the base station in the blockchain on-chain configuration information configured by the slave base station. Moreover, if the slave base station receives a UE measurement report, the slave base station collects the on-chained data corresponding to the UE side from the UE measurement report, and the slave base station forms the collected data into an on-chained data set and sends the data set to the blockchain server.

In the operation 9 (the operation 8 and the operation 9 are alternative), the slave base station sends the on-chained data set collected by the slave base station to the master base station, and the master base station forms the on-chained data set collected by the master base station, the received on-chained data set of the UE and the received on-chained data set of the slave base station into a new on-chained data set and sends the data set to the blockchain server.

Specifically, in the operation 9a, the slave base station collects the on-chained data of the base station according to the type of data that needs to be on-chained at the base station in the blockchain on-chain configuration information configured by the slave base station. Moreover, if the slave base station receives a UE measurement report, the slave base station collects the on-chained data of the UE from the UE measurement report, and the slave base station forms the collected data into an on-chained data set and sends the data set to the master base station.

In the operation 9b, the master base station collects the data of the base station according to the type of measurement data that needs to be on-chained at the base station in the blockchain on-chain configuration information configured by the master base station. Moreover, if the master base station receives a UE measurement report, the master base station collects the on-chained data of the UE from the UE measurement report, and the master base station forms the on-chained data set collected by the master base station, the received on-chained data set of the UE and the received on-chained data set of the slave base station into a new on-chained data set and sends the data set to the blockchain server.

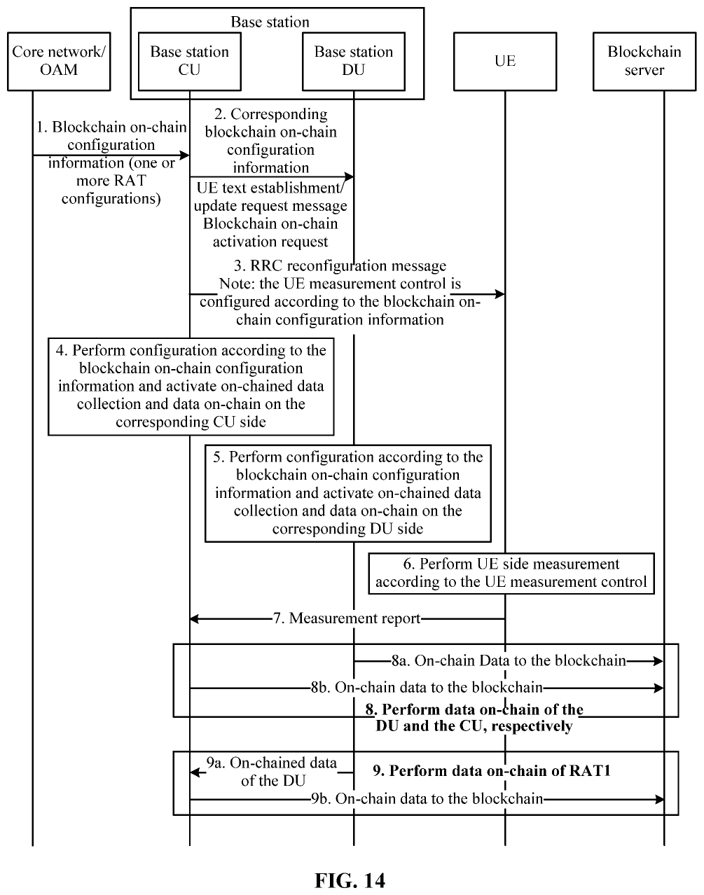

Exemplarily, the connectivity of the UE to the base station CU and the base station DU is taken as an example. The UE has established connectivity with one or more DUs, or the UE needs to establish connectivity with one or more DUs. In this embodiment, the focus is that the blockchain on-chain configuration on the DU is configured by the CU. Referring to FIG. 14, the blockchain on-chain activation and on-chain process is described below as operations 1 to 9b.

In the operation 1, in the process of UE text establishment or PDU session establishment and modification, the core network sends a message to the CU at an NG interface, where the message may be a text establishment/modification request and a PDU session establishment/modification request message, and the message carries blockchain on-chain configuration information of one or more RATs. The blockchain on-chain configuration information includes one of the following parameters.
an indication about whether a blockchain configuration is applicable to a RAT type (for example, LTE and NR), which is used for indicating which radio technology the blockchain configuration is applicable to;
a type of data that needs to be on-chained on the base station side, which is used for indicating one or more types of data that the base station needs to perform collection and on-chain on;
a type of data that needs to be on-chained at the UE, which is used for indicating one or more types of data that the UE needs to perform collection and on-chain on;
a blockchain on-chain session identifier, which is used for identifying a specified blockchain on-chain session (task); or blockchain on-chain server IP address information.

Alternatively, the blockchain on-chain configuration information of one or more RATs of the master base station is configured by the OAM entity.

According to the RAT type to which the base station belongs, the CU configures the received blockchain on-chain configuration information of the corresponding RAT to the CU. For example, if the base station is an LTE base station, the blockchain on-chain configuration information of the corresponding LTE is configured to the CU; or if the base station is a 5G base station, the blockchain on-chain configuration information of the corresponding 5G base station is configured to the CU.

In the operation 2, the CU sends the blockchain on-chain configuration information of the corresponding RAT to the DU at an F1 interface, and the CU may carry the blockchain on-chain configuration information in a UE text establishment/modification message and a blockchain on-chain activation message. The DU configures the received blockchain on-chain configuration information to the DU.

In the operation 3, according to a type of measurement data that needs to be on-chained at the UE in the blockchain on-chain configuration information configured by the CU and a type of measurement data that needs to be on-chained at the UE in the blockchain on-chain configuration information sent to the DU, the CU configures UE side measurement, and sends measurement control to the UE by carrying measurement control in an RRC message.

In the operation 4 and the operation 5, the CU and the DU activate the collection and on-chain of the corresponding on-chained data according to the type of data that needs to be on-chained on the base station side in the respectively configured blockchain on-chain configuration information.

In the operation 6, the UE performs corresponding measurement according to the measurement control.

In the operation 7, the UE sends a measurement report to the CU, where the measurement report includes relevant measurement specified in the measurement control.

In the operation 8 (the operation 8 and the operation 9 are alternative), the CU and the DU perform data collection and form on-chained data sets respectively according to the type of on-chained data in the respectively configured blockchain on-chain configuration information, and send the corresponding on-chained data sets to specific blockchain servers according to blockchain service addresses, respectively.

Specifically, in the operation 8a, the CU collects the on-chained data of the base station on the CU side according to the type of data that needs to be on-chained at the base station in the blockchain on-chain configuration information configured by the base station. Moreover, if the CU receives a UE measurement report, the CU collects the on-chained data of the UE from the UE measurement report, and the CU forms the collected data into an on-chained data set and sends the data set to the blockchain server.

In the operation 8b, the DU collects the on-chained data of the base station on the DU side according to the type of data that needs to be on-chained at the base station in the blockchain on-chain configuration information configured by the DU, and the DU forms the collected data into an on-chained data set and sends the data set to the blockchain server.

In the operation 9 (the operation 8 and the operation 9 are alternative), the DU sends the on-chained data set collected by the DU to the CU, and the CU forms the on-chained data set collected by the master base station, the received on-chained data set of the UE and the received on-chained data set of the DU into a new on-chained data set and sends the data set to the blockchain server.

Specifically, in the operation 9a, the DU collects the on-chained data of the base station on the DU side according to the type of data that needs to be on-chained at base station in the blockchain on-chain configuration information configured by the DU, and the DU forms the collected data into an on-chained data set and sends the data set to the CU.

In the operation 9b, the CU collects the on-chained data of the base station on the CU side according to the type of measurement data that needs to be on-chained at the base station in the blockchain on-chain configuration information configured by the CU. Moreover, the CU receives a UE measurement report, the CU collects the measurement on-chained data from the UE measurement report, and the CU forms the on-chained data set collected by the CU, the received on-chained data set of the UE and the received on-chained data set of the DU into a new on-chained data set and sends the data set to the blockchain server.

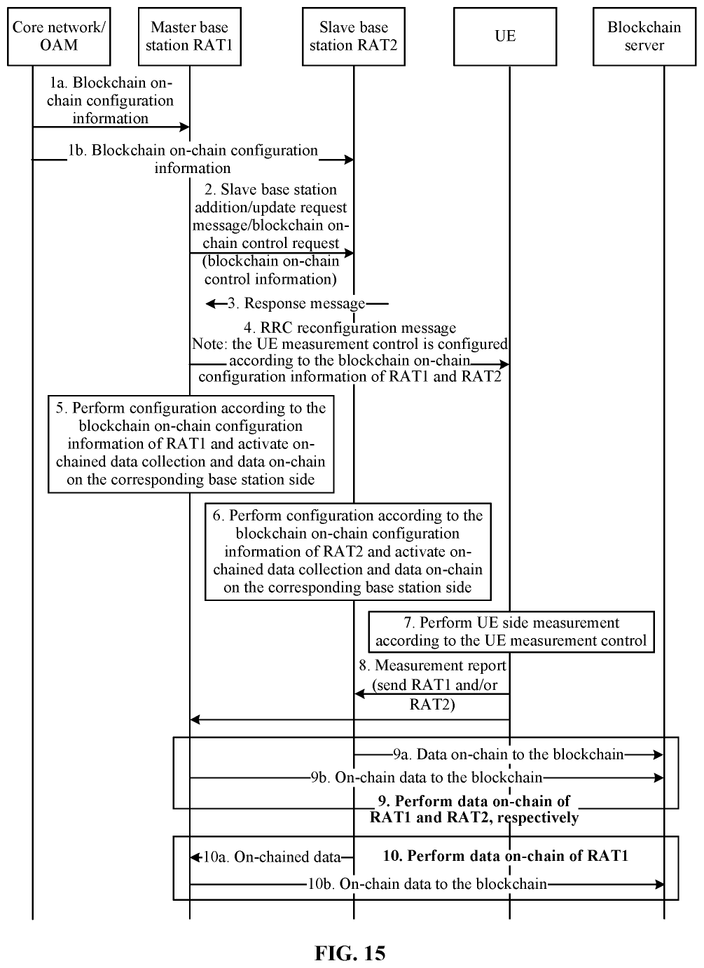

Exemplarily, the dual connectivity between the UE and the base station is taken as an example. In this example, the UE has established dual connectivity with the master base station and the slave base station, or the UE needs to establish dual connectivity with the master base station and the slave base station. In this embodiment, the focus is that the blockchain on-chain configuration on the slave base station is configured by the slave base station. The master base station and the slave base station may be base stations of the same RAT type or base stations of different RAT types. Referring to FIG. 15, the blockchain on-chain activation and on-chain process in the case of the dual connectivity of the base station includes the following operations 1 to 10b.

In the operation 1, the blockchain on-chain configuration information of the master base station is configured by the OAM entity. The master base station configures the corresponding blockchain on-chain configuration information to the master base station according to the OAM configuration. The blockchain on-chain configuration information of the slave base station is configured by the OAM entity. The slave base station configures the corresponding blockchain on-chain configuration information to the slave base station according to the OAM configuration.

In the operation 2, the master base station activates the on-chained data collection and on-chain on the corresponding master base station side according to the blockchain on-chain configuration information of the master base station.

The master base station sends the blockchain on-chain control information to the slave base station at an X2 or XN interface, and the master base station may carry the blockchain on-chain control information in a slave base station addition/modification message and a blockchain on-chain control request message. The blockchain on-chain control information carries a blockchain on-chain activation indication, where the blockchain on-chain activation indication is used for indicating the slave base station to allow the activation of the blockchain on-chained data collection and on-chain.

In the operation 3, the blockchain on-chain configuration information of the slave base station is configured by the OAM entity. When the slave base station receives the blockchain on-chain activation indication sent by the master base station, the slave base station activates the on-chained data collection and on-chain on the corresponding slave base station side according to the blockchain on-chain configuration information configured by the slave base station. The slave base station sends the blockchain on-chain configuration information configured by this base station to the master base station in a response message.

In the operation 4, according to a type of data that needs to be on-chained at the UE in the blockchain on-chain configuration information configured by the master base station and a type of data that needs to be on-chained at the UE in the received blockchain on-chain configuration information of the slave base station, the master base station configures UE side measurement, and sends measurement control to the UE by carrying measurement control in an RRC message.

In the operation 5 and the operation 6, the master base station and the slave base station activate the collection and on-chain of the corresponding on-chained data according to the type of data that needs to be on-chained on the base station side in the respectively configured blockchain on-chain configuration information.

In the operation 7, the UE performs corresponding measurement according to the measurement control.

In the operation 8, the UE sends a measurement report to the master base station or the slave base station, where the measurement report includes relevant measurement specified in the measurement control.

In the operation 9 (the operation 9 and the operation 10 are alternative), the master base station and the slave base station perform data collection and form on-chained data sets respectively according to the type of on-chained data in the respectively configured blockchain on-chain configuration information, and send the corresponding on-chained data sets to specific blockchain servers according to blockchain service addresses, respectively.

Specifically, in the operation 9a, the master base station collects the on-chained data of the base station according to the type of data that needs to be on-chained at the base station in the blockchain on-chain configuration information configured by the master base station. Moreover, if the master base station receives a UE measurement report, the master base station collects the on-chained data corresponding to the UE side from the UE measurement report, and the master base station forms the collected data into an on-chained data set and sends the data set to the blockchain server.

In the operation 9b, the slave base station collects the on-chained data of the base station according to the type of data that needs to be on-chained at the base station in the blockchain on-chain configuration information configured by the slave base station. Moreover, if the slave base station receives a UE measurement report, the slave base station collects the on-chained data corresponding to the UE side from the UE measurement report, and the slave base station forms the collected data into an on-chained data set and sends the data set to the blockchain server.

In the operation 10 (the operation 9 and the operation 10 are alternative), the slave base station sends the on-chained data set collected by the slave base station to the master base station, and the master base station forms the on-chained data set collected by the master base station, the received on-chained data set of the UE and the received on-chained data set of the slave base station into a new on-chained data set and sends the data set to the blockchain server.

Specifically, in the operation 10a, the slave base station collects the on-chained data of the base station according to the type of data that needs to be on-chained at the base station in the blockchain on-chain configuration information configured by the slave base station. Moreover, if the slave base station receives a UE measurement report, the slave base station collects the on-chained data of the UE from the UE measurement report, and the slave base station forms the collected data into an on-chained data set and sends the data set to the master base station.

In the operation 10b, the master base station collects the data of the base station according to the type of measurement data that needs to be on-chained at the base station in the blockchain on-chain configuration information configured by the master base station. Moreover, if the master base station receives a UE measurement report, the master base station collects the on-chained data of the UE from the UE measurement report, and the master base station forms the on-chained data set collected by the master base station, the received on-chained data set of the UE and the received on-chained data set of the slave base station into a new on-chained data set and sends the data set to the blockchain server.

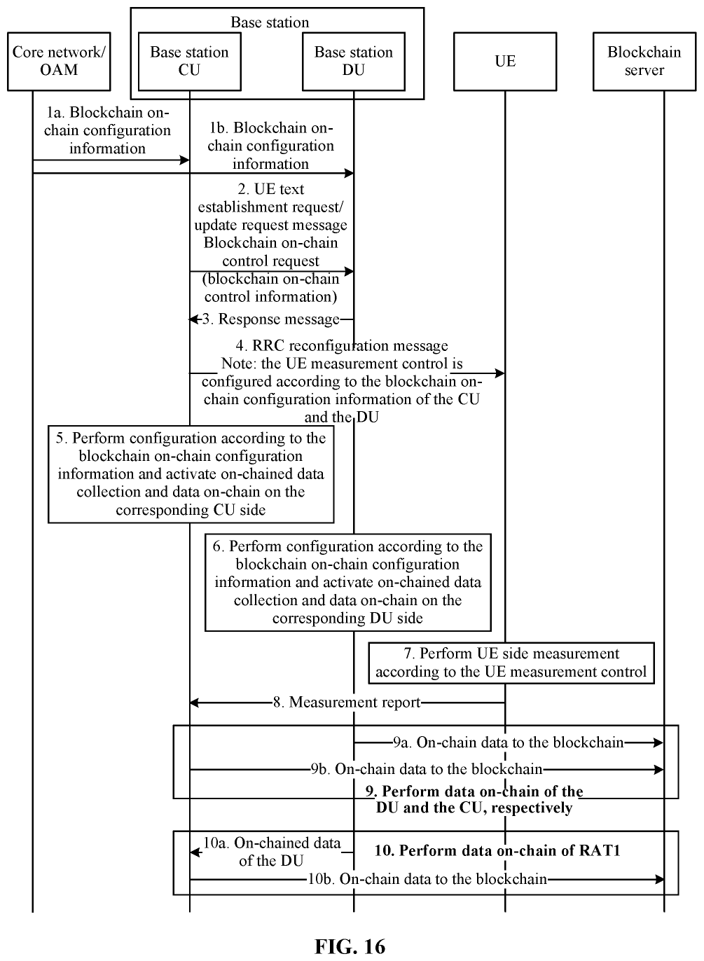

Exemplarily, the connectivity of the UE to the base station CU and the base station DU is taken as an example. The UE has established connectivity with one or more DUs, or the UE needs to establish connectivity with one or more DUs. In this embodiment, the focus is that the blockchain on-chain configuration on the DU is configured by the DU. Referring to FIG. 16, the blockchain on-chain activation and on-chain process is described below.

In the operation1, the blockchain on-chain configuration information of the CU is configured by the OAM entity. The CU configures the corresponding blockchain on-chain configuration information to the CU according to the OAM configuration. The blockchain on-chain configuration information of the DU is configured by the OAM entity. The DU configures the corresponding blockchain on-chain configuration information to the DU according to the OAM configuration.

In the operation2, the CU activates the on-chained data collection and on-chain on the corresponding CU side according to the blockchain on-chain configuration information of the CU.

The CU sends the blockchain on-chain control information to the DU at an F1 interface, and the CU may carry the blockchain on-chain control information in a UE text addition/modification message and a blockchain on-chain control request message. The blockchain on-chain control information carries a blockchain on-chain activation indication, where the blockchain on-chain activation indication is used for instructing the DU to allow the activation of the blockchain on-chained data collection and on-chain.

In the operation 3, the blockchain on-chain configuration information of the DU is configured by the OAM entity. When receiving a blockchain on-chain permission indication sent by the CU, the DU configures the corresponding blockchain on-chain configuration information to the DU according to the OAM configuration. The DU activates the on-chained data collection and on-chain on the corresponding DU side according to the blockchain on-chain configuration information of the DU. The DU sends the blockchain on-chain configuration information configured by the DU to the CU in a response message.

In the operation 4, according to a type of data that needs to be on-chained at the UE in the blockchain on-chain configuration information configured by the CU and a type of data that needs to be on-chained at the UE in the received blockchain on-chain configuration information of the DU, the CU configures UE side measurement, and sends measurement control to the UE by carrying measurement control in an RRC message.

In the operation 5 and the operation 6, the CU and the DU activate the collection and on-chain of the corresponding on-chained data according to the type of data that needs to be on-chained on the base station side in the respectively configured blockchain on-chain configuration information.

In the operation 7, the UE performs corresponding measurement according to the measurement control.

In the operation 8, the UE sends a measurement report to the CU, where the measurement report includes relevant measurement specified in the measurement control.

In the operation 9 (the operation 9 and the operation 10 are alternative), the CU and the DU perform data collection and form on-chained data sets respectively according to the type of on-chained data in the respectively configured blockchain on-chain configuration information, and send the corresponding on-chained data sets to specific blockchain servers according to blockchain service addresses, respectively.

Specifically, in the operation 9a, the CU collects the on-chained data of the base station on the CU side according to the type of data that needs to be on-chained at the base station in the blockchain on-chain configuration information configured by the base station. Moreover, if the CU receives a UE measurement report, the CU collects the on-chained data of the UE from the UE measurement report, and the CU forms the collected data into an on-chained data set and sends the data set to the blockchain server.

In the operation 9b, the DU collects the on-chained data of the base station on the DU side according to the type of data that needs to be on-chained at the base station in the blockchain on-chain configuration information configured by the DU, and the DU forms the collected data into an on-chained data set and sends the data set to the blockchain server.

In the operation 10 (the operation 9 and the operation 10 are alternative), it is indicated that the DU sends the on-chained data set collected by the DU to the CU, and the CU forms the on-chained data set collected by the master base station, the received on-chained data set of the UE and the received on-chained data set of the DU into a new on-chained data set and sends the data set to the blockchain server.

Specifically, in the operation 10a, the DU collects the on-chained data of the base station on the DU side according to the type of data type that needs to be on-chained at the base station in the blockchain on-chain configuration information configured by the DU, and the DU forms the collected data into an on-chained data set and sends the data set to the CU.

In the operation 10b, the CU collects the on-chained data of the base station on the CU side according to the type of measurement data that needs to be on-chained at the base station in the blockchain on-chain configuration information configured by the CU. Moreover, the CU receives a UE measurement report, the CU collects the measurement on-chained data from the UE measurement report, and the CU forms the on-chained data set collected by the CU, the received on-chained data set of the UE and the received on-chained data set of the DU into a new on-chained data set and sends the data set to the blockchain server.

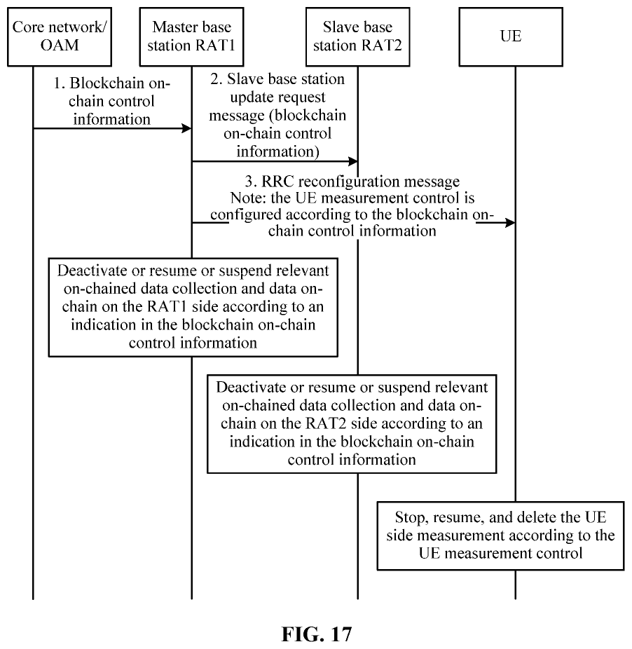

Exemplarily, the UE establishes dual connectivity with the master base station and the slave base station and has configured the blockchain on-chain configuration. Referring to FIG. 17, the deactivation, suspension, and resumption process may include the following operations 1 to 3.

In the operation 1, the blockchain on-chain control information is configured by the OAM to the master base station.

Alternatively, in the process of UE text modification and PDU session modification, the core network sends a message to the master base station at an NG interface, where the message may be a text modification request and a PDU session modification request message, and the message carries the blockchain on-chain control information. The blockchain on-chain control information includes one of the following parameters:
a blockchain on-chain session identifier, which is used for indicating a blockchain on-chain session (task) corresponding to the blockchain on-chain control information;
a UE identifier, which is used for indicating a UE corresponding to the blockchain on-chain control information;
a blockchain on-chain resumption indication, which is used for indicating a network element to resume a specified blockchain on-chain session, that is, to reactivate or start the on-chained data collection and the data on-chain of the blockchain on-chain session (task);
a blockchain on-chain suspension indication, which is used for indicating the network element to suspend the specified blockchain on-chain session, that is, to suspend the on-chained data collection and the data on-chain of the blockchain on-chain session (task); or a blockchain on-chain deactivation indication, which is used for indicating the network element to suspend the specified blockchain on-chain session, that is, to suspend the on-chained data collection and the data on-chain of the blockchain on-chain session (task) and delete the corresponding blockchain on-chain configuration information.

According to the received blockchain on-chain control information, the master base station performs corresponding operations on the blockchain on-chain session corresponding to the blockchain on-chain session identifier and the UE identifier corresponding to the blockchain on-chain control information.

If the blockchain on-chain control information received by the master base station includes the blockchain on-chain deactivation indication, the master base station suspends the on-chained data collection and the data on-chain of the blockchain on-chain session (task) and deletes the corresponding blockchain on-chain configuration information that is stored locally.

If the blockchain on-chain control information received by the master base station includes the blockchain on-chain suspension indication, the master base station suspends the on-chained data collection and the data on-chain of the blockchain on-chain session (task).

Alternatively, the current master base station has suspended the on-chained data collection and the data on-chain of the blockchain on-chain session (task), and if the received blockchain on-chain control information includes the blockchain on-chain resumption indication, the master base station resumes and starts the on-chained data collection and the data on-chain of the blockchain on-chain session (task).

In the operation 2, the master base station sends the blockchain on-chain control information to the slave base station.

According to the received blockchain on-chain control information, the slave base station performs corresponding operations on the blockchain on-chain session corresponding to the blockchain on-chain session identifier and the UE identifier corresponding to the blockchain on-chain control information. If the blockchain on-chain control information received by the slave base station includes the blockchain on-chain deactivation indication, the slave base station suspends the on-chained data collection and the data on-chain of the blockchain on-chain session (task) and deletes the corresponding blockchain on-chain configuration information that is stored locally. If the blockchain on-chain control information received by the slave base station includes the blockchain on-chain suspension indication, the slave base station suspends the on-chained data collection and the data on-chain of the blockchain on-chain session (task). Alternatively, the current slave base station has suspended the on-chained data collection and the data on-chain of the blockchain on-chain session (task), and if the received blockchain on-chain control information includes the blockchain on-chain resumption indication, the slave base station resumes and starts the on-chained data collection and the data on-chain of the blockchain on-chain session (task).

In the operation 3, optionally, according to the received blockchain on-chain control information, the main base station as described above on the blockchain on-chain session corresponding to the blockchain on-chain session identifier and the UE identifier corresponding to the blockchain on-chain control information. If the blockchain on-chain deactivation indication is received, the UE measurement control information is configured, and the type of measurement data that needs to be on-chained at the UE is deleted from the measurement control information. If the blockchain on-chain suspension indication is received, the UE measurement control information is configured, where the measurement control information includes the type of measurement data that the UE is instructed to suspend. If the blockchain on-chain resumption indication is received, the UE measurement control information is configured, where the measurement control information includes the type of measurement data that the UE is instructed to resume. The UE receives the measurement control information, and suspends resumes or deletes the corresponding measurement according to the measurement control information.

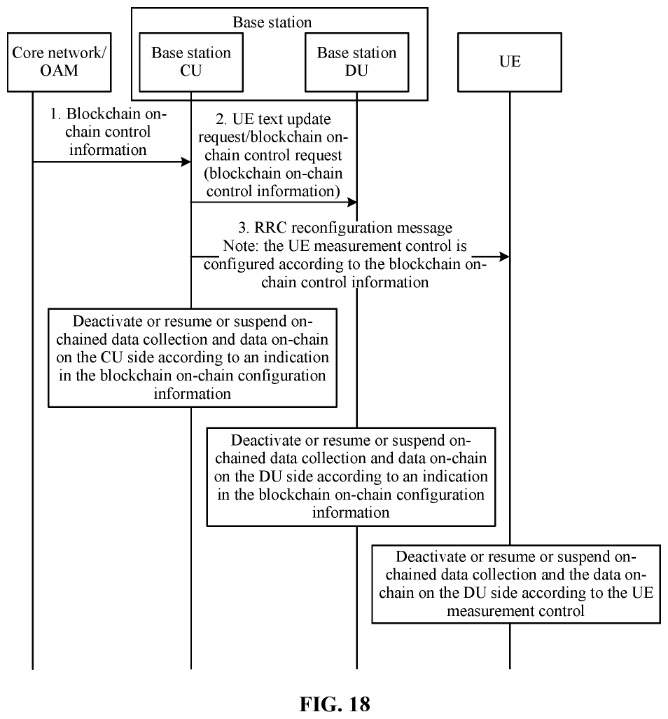

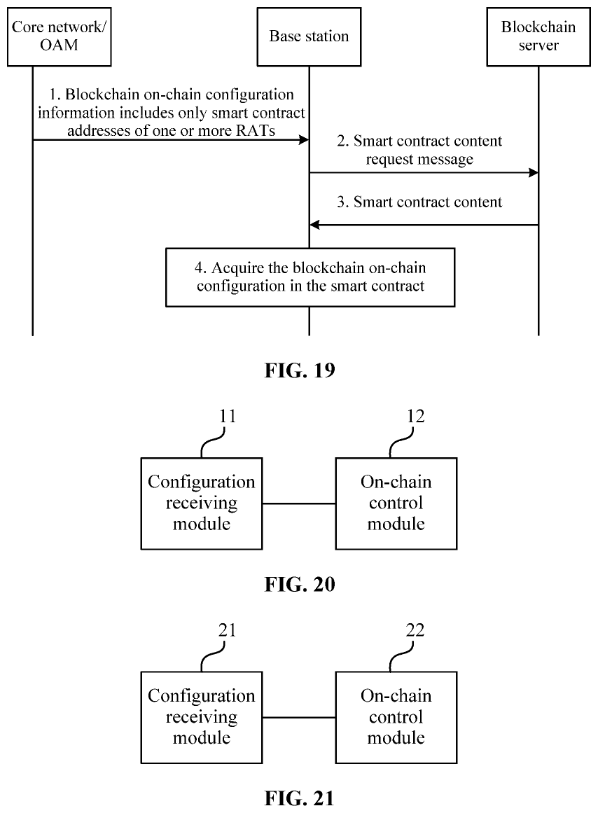

Exemplarily, the case where the UE establishes connectivity with one or more DUs and has configured the blockchain on-chain configuration is taken as an example. Referring to FIG. 18, the deactivation, suspension, and resumption process of the blockchain on-chain may include the following operations 1-3.

In the operation 1, the blockchain on-chain control information is configured by the OAM to the CU.

Alternatively, in the process of UE text modification, the core network sends a message to the CU at an NG interface, where the message may be a text modification request and a PDU session modification request message, and the message carries the blockchain on-chain control information. The blockchain on-chain control information includes one of the following parameters:
a blockchain on-chain session identifier, which is used for indicating a blockchain on-chain session (task) corresponding to the blockchain on-chain control information;
a UE identifier, which is used for indicating the UE corresponding to the blockchain on-chain control information;
a blockchain on-chain resumption indication, which is used for indicating a network element to resume a specified blockchain on-chain session, that is, to reactivate or start the on-chained data collection and the data on-chain of the blockchain on-chain session (task);
a blockchain on-chain suspension indication, which is used for indicating the network element to suspend the specified blockchain on-chain session, that is, to suspend the on-chained data collection and the data on-chain of the blockchain on-chain session (task);
a blockchain on-chain deactivation indication, which is used for indicating the network element to suspend the specified blockchain on-chain session, that is, to suspend the on-chained data collection and the data on-chain of the blockchain on-chain session (task) and delete the corresponding blockchain on-chain configuration information.

According to the received blockchain on-chain control information, the CU performs corresponding operations on the blockchain on-chain session corresponding to the blockchain on-chain session identifier and the UE identifier corresponding to the blockchain on-chain control information.

In a first operation, if the blockchain on-chain control information received by the CU includes the blockchain on-chain deactivation indication, the CU suspends the on-chained data collection and the data on-chain of the blockchain on-chain session (task) and deletes the corresponding blockchain on-chain configuration information that is stored locally.

In a second operation, if the blockchain on-chain control information received by the CU includes the blockchain on-chain suspension indication, the CU suspends the on-chained data collection and the data on-chain of the blockchain on-chain session (task).

In a third operation, alternatively, the CU has suspended the on-chained data collection and the data on-chain of the blockchain on-chain session (task), and if the received blockchain on-chain control information includes the blockchain on-chain resumption indication, the CU resumes and starts the on-chained data collection and the data on-chain of the blockchain on-chain session (task).

In the operation 2, the CU sends the blockchain on-chain control information to the DU at an F1 interface.

According to the received blockchain on-chain control information, the DU performs corresponding operations on the blockchain on-chain session corresponding to the blockchain on-chain session identifier and the UE identifier corresponding to the blockchain on-chain control information.

In a first operation, if the blockchain on-chain control information received by the DU includes the blockchain on-chain deactivation indication, the DU suspends the on-chained data collection and the data on-chain of the blockchain on-chain session (task) and deletes the corresponding blockchain on-chain configuration information that is stored locally.

In a second operation, if the blockchain on-chain control information received by the DU includes the blockchain on-chain suspension indication, the DU suspends the on-chained data collection and the data on-chain of the blockchain on-chain session (task).

In a third operation, alternatively, the DU has suspended the on-chained data collection and the data on-chain of the blockchain on-chain session (task), and if the received blockchain on-chain control information includes the blockchain on-chain resumption indication, the DU resumes and starts the on-chained data collection and the data on-chain of the blockchain on-chain session (task).

In the operation 3, optionally, according to the received blockchain on-chain control information, the CU as described above on the blockchain on-chain session corresponding to the blockchain on-chain session identifier and the UE identifier corresponding to the blockchain on-chain control information.

In a first operation, if the blockchain on-chain deactivation indication is received, the UE measurement control information is configured, where the type of measurement data that needs to be on-chained at the UE is deleted from the measurement control information.

In a second operation, if the blockchain on-chain suspension indication is received, the UE measurement control information is configured, where the measurement control information includes the type of measurement data that the UE is instructed to suspend.

In a third operation, if the blockchain on-chain resumption indication is received, the UE measurement control information is configured, where the measurement control information includes the type of measurement data that the UE is instructed to resume.

The UE receives the measurement control information, and suspends, resumes or deletes the corresponding measurement according to the measurement control information.

In an example embodiment, the blockchain on-chain configuration information received by one network element or configured by the OAM includes one of the following parameters: an indication about whether the blockchain configuration is applicable to a RAT type (for example, LTE and NR), which is used for indicating which radio technology the blockchain configuration is applicable to; a type of data that needs to be on-chained on the base station side, which is used for indicating one or more types of data that the base station needs to perform collection and on-chain on; a type of data that needs to be on-chained at the UE, which is used for indicating one or more types of data that needs to be collected and on chained on the UE side; a blockchain on-chain session identifier, which is used for identifying a specified blockchain on-chain session (task); or blockchain on-chain server IP address information.

In this embodiment, the blockchain on-chain configuration information received by one network element or configured by the OAM includes one of the following parameters: the indication about whether the blockchain configuration is applicable to a RAT type (for example, LTE and NR), which is used for indicating which radio technology the blockchain configuration is applicable to; the blockchain on-chain session identifier; or the blockchain on-chain server IP address information.

The blockchain on-chain configuration information may also include blockchain configuration on-chain smart contract address information, that is, a serial number information of a blockchain block storing a smart contract (this block stores specific blockchain on-chain configuration information, that is, the indication about whether the blockchain configuration is applicable to a RAT type; the type of data that needs to be on-chained on the base station side; and the type of data that needs to be on-chained at the UE).

That is, in this embodiment, the blockchain on-chain configuration information does not actually include the type of data that needs to be on-chained on the base station side and the type of measurement data that needs to be on-chained at the UE; instead, the blockchain on-chain configuration information stores one blockchain smart contract address storing the preceding information. The specific blockchain on-chain process may be described below as operations 1 to 3.

In the operation 1, one network element, such as the base station, receives one or more pieces of RAT-related blockchain on-chain configuration information sent by another network element; or one network element is configured by the OAM with one or more pieces of RAT-related blockchain on-chain configuration information. The blockchain on-chain configuration information includes the indication about whether the blockchain configuration is applicable to a RAT type (for example, LTE and NR), which is used for indicating which radio technology the blockchain configuration is applicable to; the blockchain on-chain session identifier; and the blockchain on-chain server IP address information.

The blockchain on-chain configuration information may also include the blockchain configuration on-chain smart contract address information, that is, the serial number information of the blockchain block storing the smart contract (this block stores specific blockchain on-chain configuration information, that is, the indication about whether the blockchain configuration is applicable to a RAT type; the type of data that needs to be on-chained on the base station side;
and the type of data that needs to be on-chained at the UE).

In the operation 2, the one network element sends a contract content request message to a corresponding blockchain server according to the blockchain configuration on-chain smart contract address information in the blockchain on-chain configuration information. The request message includes a smart contract address.

In the operation 3, the blockchain server sends the content in the corresponding smart contract address to the one network element. The content includes the indication about whether the blockchain configuration is applicable to a RAT type, the type of data that needs to be on-chained on the base station side, and the type of data that needs to be on-chained at the UE.

FIG. 20 is a structural diagram of a blockchain on-chain apparatus according to an embodiment of the present application. The blockchain on-chain apparatus may perform the blockchain on-chain method according to any embodiment of the present application and may specifically execute the corresponding functional modules and beneficial effects of the method. This apparatus may be implemented by software and/or hardware and may specifically include a configuration receiving module 11 and an on-chain control module 12.

The configuration receiving module 11 is configured to receive at least one piece of blockchain on-chain configuration information.

The on-chain control module 12 is configured to control on-chained data collection and data on-chain of a first network element and/or a second network element according to the received at least one piece of blockchain on-chain configuration information.

In the embodiment of the present application, the configuration receiving module receives at least one piece of blockchain on-chain configuration information from an OAM entity and/or a core network; and the on-chain control module controls the on-chained data collection and the data on-chain of the first network element and/or the second network element according to the received blockchain on-chain configuration information. In this manner, the blockchain technology is implemented in the wireless communication network, and the data on-chain of multiple base stations by the wireless communication network is supported, thereby improving the security and integrity of data communication.

Further, based on the preceding embodiment of the present application, the configuration receiving module 11 includes a first receiving unit and a second receiving unit.

The first receiving unit is configured to receive at least one piece of blockchain on-chain configuration information from the OAM entity and/or the core network.

The second receiving unit is configured to receive the blockchain on-chain configuration information sent by the second network element.

Further, based on the preceding embodiment of the present application, the apparatus further includes a configuration sending unit.

The configuration sending unit is configured to send the blockchain on-chain configuration information to the second network element so that the second network element performs the on-chained data collection and the data on-chain according to the blockchain on-chain configuration information.

Further, based on the preceding embodiment of the present application, the apparatus further includes a RAT configuration sending unit.

The RAT configuration sending unit is configured to, according to a radio access technology (RAT) type to which the second network element belongs, send blockchain on-chain configuration information corresponding to the RAT type to the second network element so that the second network element performs the on-chained data collection and the data on-chain according to the blockchain on-chain configuration information.

Further, based on the preceding embodiment of the present application, the apparatus further includes a control sending unit.

The control sending unit is configured to send blockchain on-chain control information to the second network element so that the second network element performs the on-chained data collection and the data on-chain according to the blockchain on-chain control information.

Further, based on the preceding embodiment of the present application, the apparatus further includes a measurement configuration unit.

The measurement configuration unit is configured to, according to the blockchain on-chain configuration information and/or the blockchain on-chain configuration information sent by the second network element, configure terminal UE measurement control and send an RRC message to the UE, where the RRC message includes the UE measurement control.

Further, based on the preceding embodiment of the present application, the apparatus further includes a blockchain operation unit.

The blockchain operation unit is configured to receive blockchain on-chain control information from the OAM entity and/or the core network; and deactivate or resume or suspend the on-chained data collection and the data on-chain according to an indication of the blockchain on-chain control information.

Further, based on the preceding embodiment of the present application, the blockchain on-chain configuration information in the apparatus includes at least one of the following parameters: an indication about whether a blockchain is adapted to a radio access type, a type of on-chained data on a base station side, a type of on-chained data on a UE side, a blockchain on-chain session identifier, and a blockchain on-chain server address.

Further, based on the preceding embodiment of the present application, the blockchain on-chain control information in the apparatus includes at least one of the following parameters: a blockchain on-chain session identifier, a UE identifier, a blockchain on-chain resumption indication, a blockchain on-chain suspension indication, a blockchain deactivation indication, or a blockchain on-chain activation indication.

Further, based on the preceding embodiment of the present application, each piece of blockchain on-chain configuration information in the apparatus is for one radio access type.

Further, based on the preceding embodiment of the present application, the second network element in the apparatus includes at least one of: a slave base station or a base station DU.

Further, based on the preceding embodiment of the present application, in the apparatus, the blockchain on-chain configuration information is received from at least one of the following messages of the OAM entity and/or the core network: a UE text establishment message, a PDU session establishment message, or a PDU session modification message.

Further, based on the preceding embodiment of the present application, in the apparatus, the blockchain on-chain configuration information is sent to the second network element through at least one of the following messages: a slave base station addition request message, a slave base station update request message, a UE text establishment request message, a UE text update request message, or a blockchain on-chain activation request message.

Further, based on the preceding embodiment of the present application, in the apparatus, the blockchain on-chain control information is sent to the second network element through at least one of the following messages: a slave base station addition request message, a slave base station update request message, a UE text establishment request message, a UE text update request message, or a blockchain on-chain control request message.

Further, based on the preceding embodiment of the present application, in the apparatus, the on-chain control module 12 is specifically configured to collect on-chained data of the first network element according to the type of on-chained data on the base station side in the blockchain on-chain configuration information; control and collect on-chained data of the UE according to the type of on-chained data on the UE side in the blockchain on-chain configuration information; and send the on-chained data of the first network element and the on-chained data of the UE to a blockchain server.

Further, based on the preceding embodiment of the present application, in the apparatus, the on-chain control module 12 is specifically configured to collect on-chained data of the first network element according to the type of on-chained data on the base station side in the blockchain on-chain configuration information; collect on-chained data of the UE according to the type of on-chained data on the UE side in the blockchain on-chain configuration information; receive combined on-chained data of the second network element reported by the second network element, where the combined on-chained data of the second network element includes on-chained data of the second network element and on-chained data of the UE collected by the second network element; and send the on-chained data of the first network element, the on-chained data of the UE, and the combined on-chained data of the second network element to a blockchain server.

Further, based on the preceding embodiment of the present application, in the apparatus, the on-chain control module 12 is specifically configured to collect on-chained data of the first network element according to the type of on-chained data on the base station side in the blockchain on-chain configuration information; collect on-chained data of the UE according to the type of on-chained data on the UE side in the blockchain on-chain configuration information; and send the on-chained data of the first network element and the on-chained data of the UE to the second network element as combined on-chained data of the first network element.

Further, based on the preceding embodiment of the present application, in the apparatus, the blockchain operation unit is specifically configured to, according to the blockchain on-chain control information, instruct the first network element to deactivate or resume or suspend the on-chained data collection and the data on-chain; send the blockchain on-chain control information to the second network element to instruct the second network element to deactivate or resume or suspend the on-chained data collection and the data on-chain; and send the blockchain on-chain control information to a UE to instruct the UE to deactivate or resume or suspend on-chained data measurement.

FIG. 21 is a structural diagram of a blockchain on-chain apparatus according to an embodiment of the present application. The blockchain on-chain apparatus may perform the blockchain on-chain method according to any embodiment of the present application and may specifically execute the corresponding functional modules and beneficial effects of the method. This apparatus may be implemented by software and/or hardware and may specifically include a configuration receiving module 21 and an on-chain control module 22.

The configuration receiving module 21 is configured to receive at least one piece of blockchain on-chain configuration information.

The on-chain control module 22 is configured to control on-chained data collection and data on-chain according to the blockchain on-chain configuration information.

In the embodiment of the present application, the configuration receiving module receives at least one piece of blockchain on-chain configuration information; and the on-chain control module controls the on-chained data collection and the data on-chain of a first network element and/or a second network element according to the received blockchain on-chain configuration information. In this manner, the blockchain technology is implemented in the wireless communication network, and the data on-chain of multiple base stations by the wireless communication network is supported, thereby improving the security and integrity of data communication.

Further, based on the preceding embodiment of the present application, the configuration receiving module 21 includes a third receiving unit and a fourth receiving unit.

The third receiving unit is configured to receive the blockchain on-chain configuration information from the first network element.

The fourth receiving unit is configured to receive the blockchain on-chain configuration information from an OAM entity and/or a core network.

Further, based on the preceding embodiment of the present application, the apparatus further includes a control receiving unit.

The control receiving unit is configured to receive blockchain on-chain control information from the first network element, and according to the blockchain on-chain control information, trigger the second network element to perform configuration according to the blockchain on-chain configuration information.

Further, based on the preceding embodiment of the present application, the apparatus further includes a configuration generation unit.

The configuration generation unit is configured to receive blockchain on-chain control information from the first network element, generate the blockchain on-chain configuration information according to a blockchain on-chain activation indication of the blockchain on-chain control information, and send the blockchain on-chain configuration information to the first network element.

Further, based on the preceding embodiment of the present application, the apparatus further includes a blockchain operation unit.

The blockchain operation unit is configured to receive blockchain on-chain control information of the first network element and deactivate or resume or suspend the on-chained data collection and the data on-chain according to an indication of the blockchain on-chain control information.

Further, based on the preceding embodiment of the present application, the blockchain on-chain configuration information in the apparatus includes at least one of the following parameters: an indication about whether a blockchain is adapted to a radio access type, a type of on-chained data on a base station side, a type of on-chained data on a UE side, a blockchain on-chain session identifier, or a blockchain on-chain server address.

Further, based on the preceding embodiment of the present application, the blockchain on-chain control information in the apparatus includes at least one of the following parameters: a blockchain on-chain session identifier, a UE identifier, a blockchain on-chain resumption indication, a blockchain on-chain suspension indication, a blockchain deactivation indication, or a blockchain on-chain activation indication.

Further, based on the preceding embodiment of the present application, each piece of blockchain on-chain configuration information in the apparatus is for one radio access type.

Further, based on the preceding embodiment of the present application, the first network element in the apparatus includes at least one of: a master base station or a base station CU.

Further, based on the preceding embodiment of the present application, in the apparatus, the blockchain on-chain configuration information is received in at least one of the following messages of the first network element.

The at least one of the following messages includes a slave base station addition request message, a slave base station update request message, a UE text establishment request message, a UE text update request message, or a blockchain on-chain activation request message.

Further, based on the preceding embodiment of the present application, in the apparatus, the blockchain on-chain control information is received in at least one of the following messages of the first network element: a slave base station addition request message, a slave base station update request message, a UE text establishment request message, a UE text update request message, or a blockchain on-chain control request message.

Further, based on the preceding embodiment of the present application, the on-chain control module 22 is specifically configured to collect on-chained data of the second network element according to the type of on-chained data on the base station side in the blockchain on-chain configuration information; control and collect on-chained data of the UE according to the type of on-chained data on the UE side in the blockchain on-chain configuration information; and send the on-chained data of the second network element and the on-chained data of the UE to a blockchain server.

Further, based on the preceding embodiment of the present application, the on-chain control module 22 is specifically configured to collect on-chained data of the second network element according to the type of on-chained data on the base station side in the blockchain on-chain configuration information; collect on-chained data of the UE according to the type of on-chained data on the UE side in the blockchain on-chain configuration information; and send the on-chained data of the second network element and the on-chained data of the UE to the first network element as combined on-chained data of the second network element.

Further, based on the preceding embodiment of the present application, the on-chain control module 22 is specifically configured to collect on-chained data of the second network element according to the type of on-chained data on the base station side in the blockchain on-chain configuration information; collect on-chained data of the UE according to the type of on-chained data on the UE side in the blockchain on-chain configuration information; receive combined on-chained data of the first network element sent by the first network element, where the combined on-chained data of the first network element includes on-chained data of the first network element and on-chained data of the UE collected by the first network element; and send the on-chained data of the second network element, the on-chained data of the UE, and the combined on-chained data of the first network element to a blockchain server.

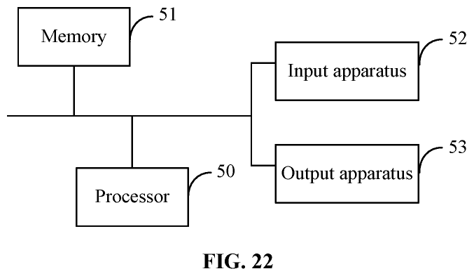

FIG. 22 is a structural diagram of an electronic device according to an embodiment of the present application. As shown in FIG. 7, the electronic device includes a processor 50, a memory 51, an input apparatus 52, and an output apparatus 53. One or more processors 50 may be provided in the electronic device. One processor 50 is taken as an example in FIG. 22. The processor 50, the memory 51, the input apparatus 52, and the output apparatus 53 in the electronic device may be connected through a bus or in other manners. In FIG. 22, connection through a bus is taken as an example.

As a computer-readable storage medium, the memory 51 may be configured to store software programs, computer-executable programs, and modules, for example, modules (the configuration receiving module 11 and the on-chain control module 12, or the configuration receiving module 21 and the on-chain control module 22) corresponding to the blockchain on-chain apparatus in the embodiment of the present application. The processor 50 runs the software programs, instructions and modules stored in the memory 51 to perform various function applications and data processing of the electronic device, that is, to perform the preceding blockchain on-chain method.

The memory 51 may mainly include a program storage region and a data storage region. The program storage region may store an operating system and an application program required by at least one function. The data storage region may store data created based on the use of the electronic device. Additionally, the memory 51 may include a high-speed random-access memory and may further include a non-volatile memory, for example, at least one magnetic disk memory, a flash memory or another non-volatile solid-state memory. In some examples, the memory 51 may further include memories which are remotely disposed with respect to the processor 50. These remote memories may be connected to the electronic device via a network. Examples of the preceding network include, but are not limited to, the Internet, an intranet, a local area network, a mobile communication network and a combination thereof.

The input apparatus 52 may be configured to receive inputted digital or character information and generate key signal input related to user settings and function control of the electronic device. The output apparatus 53 may include a display device, for example, a display screen.

An embodiment of the present application further provides a storage medium including computer-executable instructions, and the computer-executable instructions are used for performing a blockchain on-chain method when executed by a computer processor. The blockchain on-chain method includes: receiving at least one piece of blockchain on-chain configuration information; and controlling on-chained data collection and data on-chain of a first network element and/or a second network element according to the received blockchain on-chain configuration information.

Alternatively, the blockchain on-chain method includes: receiving at least one piece of blockchain on-chain configuration information; and controlling on-chained data collection and data on-chain according to the blockchain on-chain configuration information.

From the preceding description of embodiments, it is apparent to those skilled in the art that the present application may be implemented by use of software and necessary general-purpose hardware or may be implemented by hardware. Based on this understanding, the technical solutions of the present application substantially, or the part contributing to the related art, may be embodied in the form of a software product. The computer software product may be stored in a computer-readable storage medium such as a floppy disk, a read-only memory (ROM), a random-access memory (RAM), a flash memory, a hard disk, or an optical disk of a computer and includes several instructions for causing a computer device (which may be a personal computer, a server, or a network device) to perform the method in the embodiments of the present application.

It is to be noted that units and modules involved in the embodiment of the blockchain on-chain apparatus are just divided according to functional logic, and the division is not limited to this, as long as the corresponding functions can be achieved. In addition, the specific names of functional units are just intended for distinguishing and are not to limit the scope of the present application.

It is to be understood by those having ordinary skill in the art that some or all steps of the preceding method and function modules/units in the preceding system or device may be implemented as software, firmware, hardware and suitable combinations thereof.

In the hardware implementation, the division of the preceding functional modules/units may not correspond to the division of physical components. For example, one physical component may have multiple functions, or one function or step may be performed jointly by several physical components. Some or all physical components may be implemented as software executed by a processor such as a central processing unit, a digital signal processor or a microprocessor, may be implemented as hardware, or may be implemented as integrated circuits such as application-specific integrated circuits. Such software may be distributed over computer-readable media. The computer-readable media may include computer storage media (or non-transitory media) and communication media (or transitory media). As is known to those having ordinary skill in the art, the term computer storage media include volatile and non-volatile as well as removable and non-removable media implemented in any method or technology for storing information (such as computer-readable instructions, data structures, program modules or other data). The computer storage media include, but are not limited to, an RAM, an ROM, an electrically erasable programmable read-only memory (EEPROM), a flash memory, or other memory technologies, a compact disc read-only memory (CD-ROM), a digital video disc (DVD) or other optical disk memories, a magnetic cassette, a magnetic tape, a magnetic disk memory or other magnetic storage apparatuses, or any other medium used for storing the desired information and accessible by a computer. Moreover, as is known to those having ordinary skill in the art, the communication media generally include computer-readable instructions, data structures, program modules or other data in carriers or in modulated data signals transported in other transport mechanisms and may include any information delivery medium.

1. A blockchain on-chain method, applied to a first network element, comprising:
receiving at least one piece of blockchain on-chain configuration information; and
controlling on-chained data collection and data on-chain of at least one of the first network element or a second network element according to the received at least one piece of blockchain on-chain configuration information.

2. The method of claim 1, wherein the receiving the at least one piece of blockchain on-chain configuration information comprises at least one of:
receiving the at least one piece of blockchain on-chain configuration information from at least one of an operation administration and maintenance (OAM) entity or a core network; or
receiving blockchain on-chain configuration information sent by the second network element,
wherein the at least one piece of blockchain on-chain configuration information is received from at least one of the following messages of the at least one of the OAM entity or the core network:
a UE text establishment message, a protocol data unit (PDU) session establishment message, or a PDU session modification message.

3. The method of claim 1, further comprising:
sending part or all of the at least one piece of blockchain on-chain configuration information to the second network element, wherein the part or all of the at least one piece of blockchain on-chain configuration information is used for the second network element to perform the on-chained data collection and the data on-chain,
wherein the blockchain on-chain configuration information is sent to the second network element through at least one of the following messages:
a slave base station addition request message, a slave base station update request message, a UE text establishment request message, a UE text update request message, or a blockchain on-chain activation request message.

4. The method of claim 1, further comprising:
sending, according to a radio access technology (RAT) type to which the second network element belongs, blockchain on-chain configuration information corresponding to the RAT type to the second network element, wherein the blockchain on-chain configuration information corresponding to the RAT type is used for the second network element to perform the on-chained data collection and the data on-chain.

5. The method of claim 1, further comprising:
sending blockchain on-chain control information to the second network element, wherein blockchain on-chain control information is used for the second network element to perform the on-chained data collection and the data on-chain,
wherein the blockchain on-chain control information comprises at least one of the following parameters:
a blockchain on-chain session identifier, a UE identifier, a blockchain on-chain resumption indication, a blockchain on-chain suspension indication, a blockchain deactivation indication, or a blockchain on-chain activation indication; and
wherein the blockchain on-chain control information is sent to the second network element through at least one of the following messages:
a slave base station addition request message, a slave base station update request message, a UE text establishment request message, a UE text update request message, or a blockchain on-chain control request message.

6. The method of claim 1, further comprising:
configuring, according to at least one of the at least one piece of blockchain on-chain configuration information or blockchain on-chain configuration information sent by the second network element, user equipment (UE) measurement control, and sending a radio resource control (RRC) message to the UE, wherein the RRC message comprises the UE measurement control.

7. The method of claim 1, further comprising:
receiving blockchain on-chain control information from at least one of an OAM entity or a core network; and
instructing, according to the blockchain on-chain control information, deactivation, resumption or suspension to be performed on the on-chained data collection and the data on-chain,
wherein the instructing, according to the blockchain on-chain control information, deactivation, resumption or suspension to be performed on the on-chained data collection and the data on-chain comprises at least one of:
instructing, according to the blockchain on-chain control information, the first network element to deactivate or resume or suspend the on-chained data collection and the data on-chain;
sending the blockchain on-chain control information to the second network element to instruct the second network element to deactivate or resume or suspend the on-chained data collection and the data on-chain; or
sending the blockchain on-chain control information to a UE to instruct the UE to deactivate or resume or suspend on-chained data measurement.

8. The method of claim 1, wherein each of the at least one piece of blockchain on-chain configuration information comprises at least one of the following parameters:
an indication about whether a blockchain is adapted to a radio access type, a type of on-chained data on a base station side, a type of on-chained data on a UE side, a blockchain on-chain session identifier, or a blockchain on-chain server address.

9.-14. (canceled)

15. The method of claim 1, wherein controlling the on-chained data collection and the data on-chain according to the received at least one piece of blockchain on-chain configuration information comprises:
collecting on-chained data of the first network element according to a type of on-chained data on a base station side in the at least one piece of blockchain on-chain configuration information;
controlling and collecting on-chained data of a UE according to a type of on-chained data on a UE side in the at least one piece of blockchain on-chain configuration information; and
sending the on-chained data of the first network element and the on-chained data of the UE to a blockchain server,
wherein the instructing, according to the blockchain on-chain control information, deactivation, resumption or suspension to be performed on the on-chained data collection and the data on-chain comprises at least one of:
instructing, according to the blockchain on-chain control information, the first network element to deactivate or resume or suspend the on-chained data collection and the data on-chain;
sending the blockchain on-chain control information to the second network element to instruct the second network element to deactivate or resume or suspend the on-chained data collection and the data on-chain; or
sending the blockchain on-chain control information to a UE to instruct the UE to deactivate or resume or suspend on-chained data measurement.

16. (canceled)

17. The method of claim 1, wherein controlling the on-chained data collection and the data on-chain according to the received at least one piece of blockchain on-chain configuration information comprises:
collecting on-chained data of the first network element according to a type of on-chained data on a base station side in the at least one piece of blockchain on-chain configuration information;
collecting on-chained data of a UE according to a type of on-chained data on a UE side in the at least one piece of blockchain on-chain configuration information; and
sending the on-chained data of the first network element and the on-chained data of the UE to the second network element as combined on-chained data of the first network element.

18. (canceled)

19. A blockchain on-chain method, applied to a second network element, comprising:
receiving at least one piece of blockchain on-chain configuration information; and
controlling on-chained data collection and data on-chain according to the at least one piece of blockchain on-chain configuration information.

20. The method of claim 19, wherein the receiving the at least one piece of blockchain on-chain configuration information comprises at least one of:
receiving the at least one piece of blockchain on-chain configuration information from a first network element; or
receiving the at least one piece of blockchain on-chain configuration information from at least one of an operation administration and maintenance (OAM) entity or a core network,
wherein the at least one piece of blockchain on-chain configuration information is received in at least one of the following messages of the first network element:
a slave base station addition request message, a slave base station update request message, a UE text establishment request message, a UE text update request message, or a blockchain on-chain activation request message.

21. The method of claim 20, wherein after receiving the at least one piece of blockchain on-chain configuration information from the at least one of the OAM entity or the core network, the method further comprises:
receiving blockchain on-chain control information from the first network element, and triggering, according to the blockchain on-chain control information, the second network element to perform configuration according to the at least one piece of blockchain on-chain configuration information,
wherein the blockchain on-chain control information comprises at least one of the following parameters:
a blockchain on-chain session identifier, a UE identifier, a blockchain on-chain resumption indication, a blockchain on-chain suspension indication, a blockchain deactivation indication, or a blockchain on-chain activation indication.

22. The method of claim 19, further comprising:
receiving blockchain on-chain control information from a first network element, generating the at least one piece of blockchain on-chain configuration information according to a blockchain on-chain activation indication of the blockchain on-chain control information, and sending the blockchain on-chain configuration information to the first network element.

23. The method of claim 19, further comprising:
receiving blockchain on-chain control information of a first network element, and deactivating or resuming or suspending the on-chained data collection and the data on-chain according to an indication of the blockchain on-chain control information,
wherein the blockchain on-chain control information comprises at least one of the following parameters:
a blockchain on-chain session identifier, a UE identifier, a blockchain on-chain resumption indication, a blockchain on-chain suspension indication, a blockchain deactivation indication, or a blockchain on-chain activation indication.

24. The method of claim 19, wherein each of the at least one piece of blockchain on-chain configuration information comprises at least one of the following parameters:
an indication about whether a blockchain is adapted to a radio access type, a type of on-chained data on a base station side, a type of on-chained data on a UE side, a blockchain on-chain session identifier, or a blockchain on-chain server address.

25.-29. (canceled)

30. The method of claim 19, wherein the controlling the on-chained data collection and the data on-chain according to the at least one piece of blockchain on-chain configuration information comprises:
collecting on-chained data of a second network element according to a type of on-chained data on a base station side in the at least one piece of blockchain on-chain configuration information;
controlling and collecting on-chained data of a UE according to a type of on-chained data on a UE side in the at least one piece of blockchain on-chain configuration information; and
sending the on-chained data of the second network element and the on-chained data of the UE to a blockchain server.

31. The method of claim 21, wherein the controlling the on-chained data collection and the data on-chain according to the at least one piece of blockchain on-chain configuration information comprises:
collecting on-chained data of a second network element according to a type of on-chained data on a base station side in the at least one piece of blockchain on-chain configuration information;
collecting on-chained data of a UE according to a type of on-chained data on a UE side in the at least one piece of blockchain on-chain configuration information; and
sending the on-chained data of the second network element and the on-chained data of the UE to the first network element as combined on-chained data of the second network element,
or,
wherein the controlling the on-chained data collection and the data on-chain according to the at least one piece of blockchain on-chain configuration information comprises:
collecting on-chained data of a second network element according to a type of on-chained data on a base station side in the at least one piece of blockchain on-chain configuration information;
collecting on-chained data of a UE according to a type of on-chained data on a UE side in the at least one piece of blockchain on-chain configuration information;
receiving combined on-chained data of the first network element sent by the first network element, wherein the combined on-chained data of the first network element comprises on-chained data of the first network element and on-chained data of the UE collected by the first network element; and
sending the on-chained data of the second network element, the on-chained data of the UE, and the combined on-chained data of the first network element to a blockchain server.

32.-34. (canceled)

35. An electronic device, comprising:
at least one processor; and
a memory configured to store at least one program,
wherein the at least one program, when executed by the at least one processor, causes the at least one processor to perform:
receiving at least one piece of blockchain on-chain configuration information; and
controlling on-chained data collection and data on-chain of at least one of a first network element or a second network element according to the received at least one piece of blockchain on-chain configuration information.

36. A non-transitory computer-readable storage medium, which is configured to store a computer program, wherein the computer program is executed by a processor to perform the blockchain on-chain method of claim 1.
